(19) United States
(12) Patent Application Publication
(10) Pub. No.: US 2020/0170081 A1
(43) Pub. Date: May 28, 2020

(54) HEATING APPLIANCE

(71) Applicant: NXP USA, Inc., Austin, TX (US)

(72) Inventors: Jamison Michael McCarville, Tempe, AZ (US); Hung Hoa Tran, Chandler, AZ (US); Gavin James Smith, Gilbert, AZ (US); Lionel Mongin, Chandler, AZ (US)

(21) Appl. No.: 16/773,619

(22) Filed: Jan. 27, 2020

Related U.S. Application Data
(63) Continuation-in-part of application No. 15/923,455, filed on Mar. 16, 2018.

(51) Int. Cl. H05B 6/62; H05B 6/50; H05B 11/00; H05B 3/00; H05B 6/68; H05B 6/54; A47J 36/32; A47J 27/00

(52) U.S. Cl. CPC H05B 6/62; H05B 6/50; H05B 11/00; A47J 27/004; H05B 6/686; H05B 6/54; A47J 36/32; H05B 3/0014

(57) ABSTRACT

A system includes a cavity configured to receive a container. The container is configured to contain a plurality of grains. The system includes a radio frequency (RF) signal source configured to supply an RF signal, an impedance matching network electrically coupled to an output of the RF signal source, a transmission path coupled to the impedance matching network, and a first electrode in the cavity. The first electrode is coupled to the transmission path and configured to radiate electromagnetic energy into the cavity as a result of receiving the RF signal. The system includes power detection circuitry configured to measure a magnitude of a reflected signal along the transmission path and a controller configured to modify an impedance transformation performed by the impedance matching network based on the magnitude of the reflected signal.

### CROSS-REFERENCE TO RELATED APPLICATIONS

This application in a continuation-in-part of U.S. patent application Ser. No. 15/923,455 entitled “DEFROSTING APPARATUS AND METHODS OF OPERATION THEREOF” and filed on Mar. 16, 2018, the entirety of which is hereby incorporated by reference.

### TECHNICAL FIELD

Embodiments of the subject matter described herein relate generally to an apparatus for and methods of operating a heating appliance that uses electromagnetic energy to work or heat a food load.

### BACKGROUND

Capacitive food heating systems include planar electrodes contained within a heating compartment. After a food load is placed between the electrodes, electromagnetic energy is supplied to the electrodes to provide warming or cooking of the food load.

As the food load cooks during the heating operation, the impedance of the food load changes. The dynamic changes to the food load impedance may result in inefficient heating of the food load. What are needed are apparatus and methods for heating food loads (or other types of loads) that may result in efficient and even heating throughout the food load.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a perspective view of a heating appliance with a radio frequency (RF) heating system, in accordance with an example embodiment.

FIG. 2A is a simplified block diagram of a heating apparatus with an RF heating system, in accordance with an example embodiment.

FIG. 2B is a simplified block diagram of a balanced heating apparatus with an RF heating system and a thermal heating system, in accordance with another example embodiment.

FIG. 3 is a simplified block diagram of a heating apparatus with an RF heating system for cooking grain-based food loads, in accordance with an example embodiment.

FIGS. 4, 5A, and 5B are illustrations of example electrodes that may be utilized within an RF heating system, in accordance with an example embodiment.

FIG. 6 is a flow chart depicting a method of cooking a food load, such as a grain-based food load, using an RF heating system, in accordance with an embodiment.

### DETAILED DESCRIPTION

The following detailed description is merely illustrative in nature and is not intended to limit the embodiments of the subject matter or the application and uses of such embodiments. As used herein, the words “exemplary” and “example” mean “serving as an example, instance, or illustration.” Any implementation described herein as exemplary or an example is not necessarily to be construed as preferred or advantageous over other implementations. Furthermore, there is no intention to be bound by any expressed or implied theory presented in the preceding technical field, background, or the following detailed description.

Embodiments of the subject matter described herein relate to appliances or heating systems configured to heat or cook a food load using radio frequency (RF) energy. In an embodiment, the appliances, as described herein, may be utilized to heat and cook grain-based foods, such as corn. Example heating appliances, apparatus, and/or systems may include one or more heating systems that can operate simultaneously in order to heat a load (e.g., a food load) within a heating cavity.

The heating appliance or system may be implemented as a popcorn cooking system that uses relatively low-frequency RF energy to cook corn kernels into popcorn. The appliance includes a heating cavity into which uncooked corn kernels (or other grains) may be placed. Once the heating process is initiated, the appliance applies RF energy to the uncooked kernels via one or more electrodes disposed within the heating cavity. The RF energy can be relatively high-magnitude and low-frequency RF energy configured to heat the uncooked kernels. In an embodiment, the RF energy is generated using a solid-state low frequency (1 MHz-300 MHz) RF energy source, as described herein. When the kernels are cooked and pop, the popcorn may be ejected from or fall out of the heating cavity using any suitable ejection mechanism.

In an embodiment, the appliance may include only an RF heating system without other heating systems. Such an RF heating system includes a solid-state RF signal source, a variable impedance matching network, and two electrodes, where the two electrodes are separated by the heating cavity. More specifically, the RF heating system may be implemented as a “capacitive” heating system, in that the two electrodes function as electrodes (or plates) of a capacitor, and the capacitor dielectric essentially includes the portion of the cavity between the two electrodes and any load (e.g., grains, kernels, or other food material) contained therein.

In other embodiments, the appliance may optionally include multiple heating systems that include an RF heating system and a “thermal” heating system. The thermal heating system can include any one or more systems that heat the air within the cavity, such as one or more resistive heating elements.

Embodiments of the RF heating system, which is included in the heating appliance along with the optional thermal heating system, differ from a conventional microwave oven system in several respects. For example, embodiments of the RF heating system include a solid-state RF signal source, as opposed to a magnetron that is utilized in a conventional microwave oven system. Utilization of a solid-state RF signal source may be advantageous over a magnetron, in that a solid-state RF signal source may be significantly lighter and smaller, and may be less likely to exhibit performance degradation (e.g., power output loss) over time.

In addition, embodiments of the RF heating system may generate electromagnetic energy in the heating cavity at frequencies that are significantly lower than the 2.54 gigahertz (GHz) frequency that is typically used in conventional microwave oven systems. In some embodiments, for example, embodiments of the heating system generate electromagnetic energy in the heating cavity at frequencies within the VHF (very high frequency) range (e.g., from 30 megahertz (MHz) to 300 MHz). The significantly lower frequencies utilized in the various embodiments may result in deeper energy penetration into the load, and thus potentially faster and more even heating. Further still, embodiments of the RF heating system can include a single-ended or double-ended variable impedance matching network, which is dynamically controlled based on the magnitude of reflected RF power from the appliance's heating cavity. This dynamic control enables the system to provide a good match between the RF signal generator and the system heating cavity (plus load) throughout a heating process, which may result in increased system efficiency and reduced heating time.

In various implementations, impedance matching networks incorporated into the heating appliance may have a relatively large number of potential impedance states. That is, the impedance matching networks can exhibit a large number of different impedances between an input to the impedance matching network and the network's output. The different impedance states may be selected, for example, by supplying the impedance matching network with different control inputs (e.g., supplied by a system controller), which are selected to configure the state of one or more internal components of the impedance matching network. With the states of those internal components so configured, the impedance of the impedance matching network can be controlled.

In the appliance, the impedance of the impedance matching networks may be configured to provide optimum RF power delivery into the load being heated within the heating cavity. This generally involves selecting an impedance value for the impedance matching network that minimizes or reduces and amount of reflected energy from the heating cavity of the heating system. By reducing an amount of reflected energy from the heating cavity, this approach can maximize or increase an amount of RF energy that is being delivered into a load positioned within the heating cavity. By providing such optimized RF power delivery into the load, the load, such as a grain, can be heated more efficiently and more quickly.

Some variable impedance matching network embodiments may be configurable into a large number of states, each state exhibiting a different impedance value or providing a different impedance transformation between an input and an output to the variable impedance matching network. Some networks, for example, may have thousands (e.g., 2,048 or some other number) of possible impedance matching states, each exhibiting a different magnitude of impedance transformation between the input and output of the network.

In still other embodiments, impedance matching between the RF signal source and the heating cavity of the appliance may be achieved by the appliance varying the frequency of the RF signal being generated by the appliance's RF heating system. In various embodiments, the appliance may use both frequency adjustments in combination with variable impedance matching networks to achieve optimized impedance matching between the appliance's RF heating system and the appliance's heating cavity.

Generally, the term “heating” means to elevate the temperature of a load (e.g., a food load or other type of load). As used herein, the term “heating” more broadly means a process by which the thermal energy or temperature of a load (e.g., a food load or other type of load) is increased through provision of thermal radiation of air particles and/or RF electromagnetic energy applied to the load. Accordingly, in various embodiments, a “heating operation” may be performed on a load with any initial temperature, and the heating operation may be ceased at any final temperature that is higher than the initial temperature. That said, the “heating operations” and “heating systems” described herein alternatively may be referred to as “thermal increase operations” and “thermal increase systems.” The term “cooking” refers to the process of heating a food load.

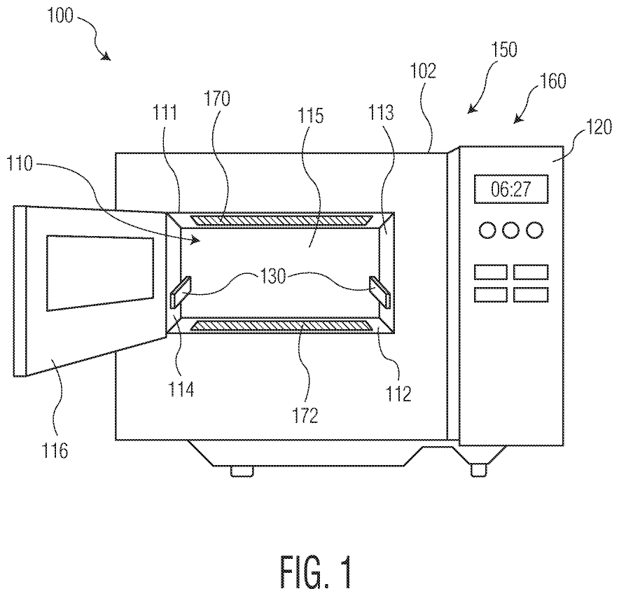

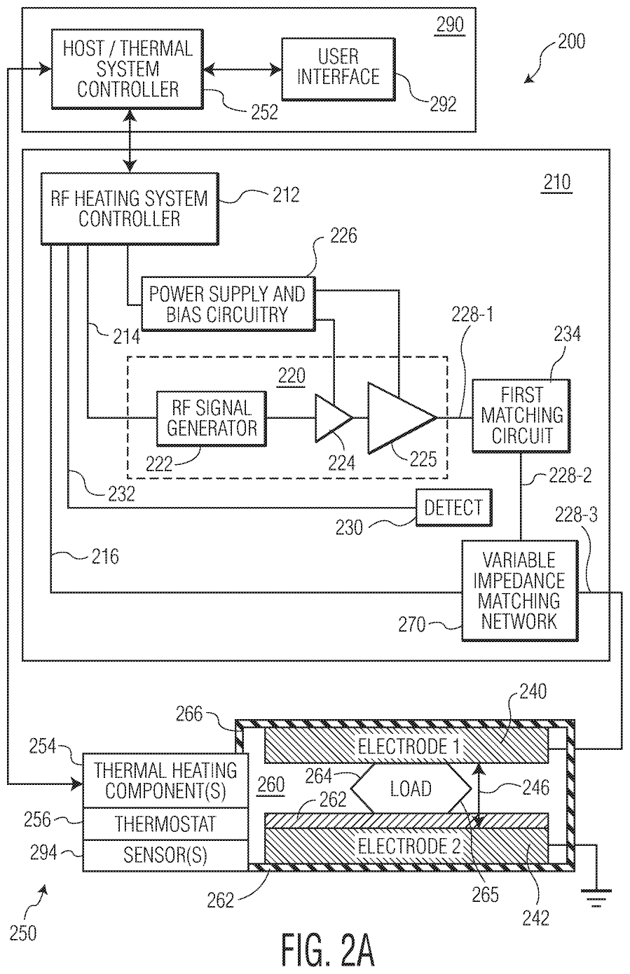

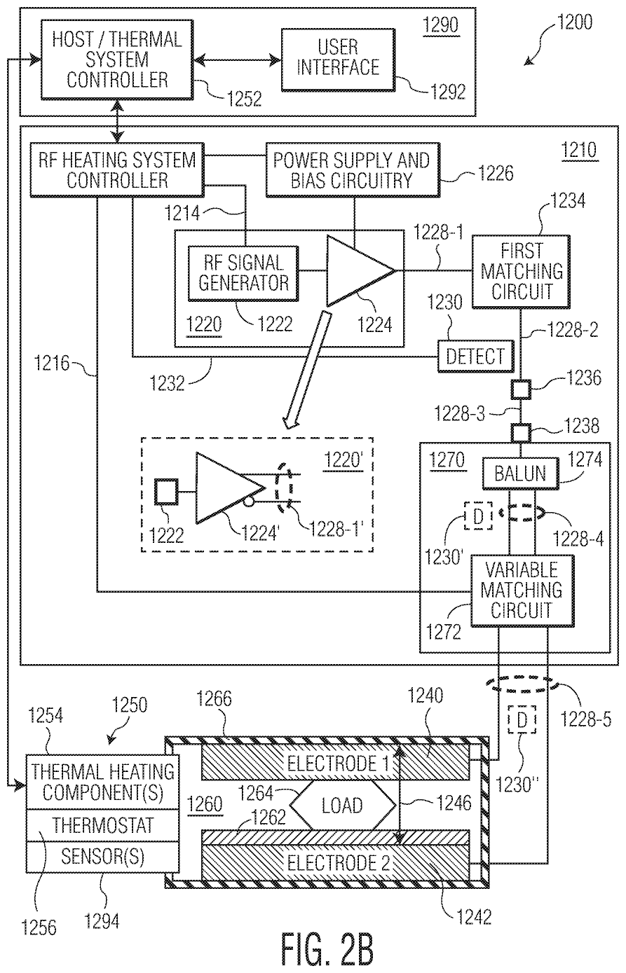

FIG. 1 is a perspective view of a heating system 100 (or appliance), in accordance with an example embodiment. Heating system 100 includes a heating cavity 110 (e.g., cavity 260, 1260, FIGS. 2A, 2B), a control panel 120, an RF heating system 150 (e.g., RF heating system 210, 1210, FIGS. 2A, 2B), and an optional thermal heating system 160 (e.g., thermal heating system 250, 1250, FIG. 2A, 2B), all of which are secured within a system housing 102. The heating cavity 110 is defined by interior surfaces of top, bottom, side, and back cavity walls 111, 112, 113, 114, 115. An optional door 116 may be optionally positioned over heating cavity 110 and retained by a latching mechanism to fully enclose the heating cavity 110.

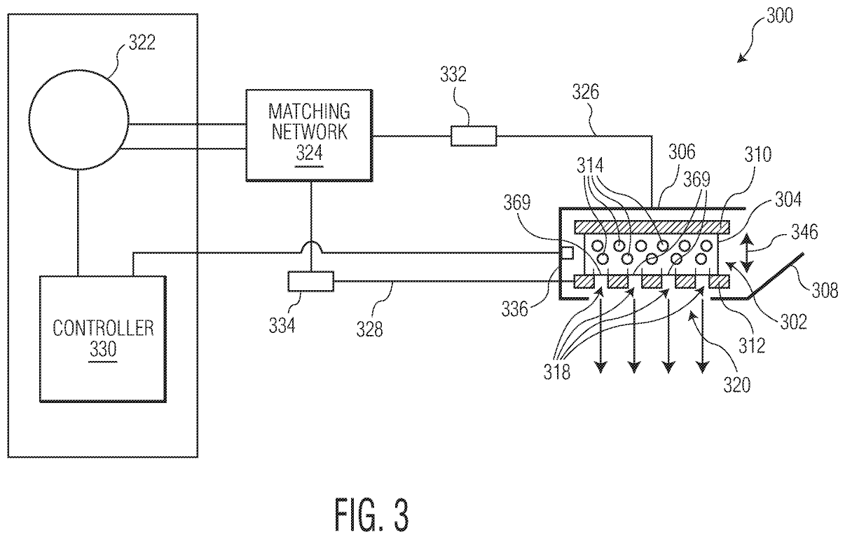

In some embodiments, one or more retention structures 130 are accessible within the heating cavity 110. When a food load container (see, for example, container 304 of FIG. 3) is positioned within heating cavity 110, retention structures 130 may be configured to engage with mating structures formed in an exterior surface of the food load container to retain the food load container within the heating cavity 110 in a particular position (e.g., a particular distance away from one or more of electrodes 170 and 172) and orientation with respect to the heating cavity 110. In an embodiment, the food load container may be a manufactured package containing a pre-determined amount of food load (e.g., a particular volume or grain or number of corn kernels) configured to be heated or cooked within the heating cavity 110. In such an embodiment, the container may include a material that is generally permeable (i.e., transparent) to the RF energy transmitted into the heating cavity 110 by the heating system 110 so that the container does not absorb the RF energy and it is instead transmitted into the food load contained within the container. In various embodiments, such a container may include any suitable materials (e.g., microwave-safe materials), such as polypropylenes, polymethylpentene, polysulfone, Polytetrafluoroethylene (PTFE), or combinations thereof. The container may also contain, in addition to the food load, various additional materials that may modify the flavor of the food load or improve or modify the process of cooking the food load (e.g., flavoring additives, salt, oils or fats, such as butter, and the like). In various other embodiments, of the heating system 100, however, a food load may be placed directly into the heating cavity 110 and may not be contained in a container or other structure that would contain the food load. In other words, food loads may be heated with the heating system 100 without a container.

Heating system 100 includes an RF heating system 150 (e.g., RF heating system 210, 1210, FIGS. 2A, 2B). As shown in FIG. 1, the heating system 100 may optionally include a thermal heating system 160, which heats the air in heating cavity 110 and may include any of resistive heating elements, a convection blower, a convection fan plus a resistive heating element, a gas heating system, or other heating elements.

As will be described in greater detail below, the RF heating system 150 includes one or more radio frequency (RF) signal sources (e.g., RF signal source 220, 1220, FIGS. 2A, 2B), a power supply (e.g., power supply 226, 1226, FIGS. 2A, 2B), a first electrode 170 (e.g., electrode 240, 1240, FIGS. 2A, 2B), a second electrode 172 (e.g., electrode 242, 1242, FIGS. 2A, 2B), impedance matching circuitry (e.g., network 270, 1234, 1270, FIGS. 2A, 2B), power detection circuitry (e.g., power detection circuitry 230, 1230, FIGS. 2A, 2B), and an RF heating system controller (e.g., system controller 212, 1212, FIGS. 2A, 2B).

The first electrode 170 is arranged proximate to a cavity wall (e.g., top wall 111), and the second electrode 172 is arranged proximate to an opposite, second cavity wall (e.g., bottom wall 112). Alternatively, as indicated above, the second electrode 172 may be replaced by a removable shelf structure or an electrode within such a shelf structure. Either way, the first and second electrodes 170, 172 are electrically isolated from the remaining cavity walls (e.g., walls 113-115 and door 116), and the remaining cavity walls may be grounded. In either configuration, the system may be simplistically modeled as a capacitor, where the first electrode 170 functions as one conductive plate (or electrode), the second electrode 172 functions as a second conductive plate (or electrode), and the air cavity between the electrodes 170, 172 (including any load contained therein) functions as a dielectric medium between the first and second conductive plates.

The RF heating system 150 may be an “unbalanced” RF heating system or a “balanced” RF heating system, in various embodiments. As will be described in more detail later in conjunction with FIG. 2A, when configured as an “unbalanced” RF heating system, the system 150 includes a single-ended amplifier arrangement (e.g., amplifier arrangement 220, FIG. 2A), and a single-ended impedance matching network (e.g., including networks 234, 270, FIG. 2A) coupled between an output of the amplifier arrangement and the first electrode 170, and the second electrode 172 is grounded. Although alternatively the first electrode 170 could be grounded, and the second electrode 172 could be coupled to the amplifier arrangement. In contrast, when configured as a “balanced” RF heating system, the system 150 includes a single-ended or double-ended amplifier arrangement, and a double-ended impedance matching network coupled between an output of the amplifier arrangement and the first and second electrodes 170, 172. In either the balanced or unbalanced embodiments, the impedance matching network includes a variable impedance matching network that can be adjusted during the heating operation to improve matching between the amplifier arrangement and the cavity (plus load). Further, a measurement and control system can detect certain conditions related to the heating operation (e.g., an empty system cavity, a poor impedance match, and/or completion of a heating operation).

The thermal heating system 160 includes a thermal system controller (e.g., thermal system controller 252, 1252, FIGS. 2A, 2B), a power supply, a heating element or component, and a thermostat, in an embodiment. The heating element may be, for example, a resistive heating element, which is configured to heat air surrounding the heating element when current from the power supply is passed through the heating element. In such an embodiment, the resistive heating element could be positioned to be in physical contact with a food load container when the container is positioned within the heating cavity of the heating system 160.

Referring again to FIG. 1, and according to an embodiment, during operation of the heating system 100, a user (not illustrated) may first place one or more food load containers (e.g., a container containing an amount of grain-based food material) into the heating cavity 110. As described previously, such a food container may engage with one or more retention structures 130 within the heating cavity 110 to retain the container with in the heating cavity 110 in a particular location and orientation with respect to the heating cavity 110 and components thereof.

To initiate a cooking process, the user may specify a type of cooking (or cooking mode) that the user would like the system 100 to implement. The user may specify the cooking mode through the control panel 120 (e.g., by pressing a button or making a cooking mode menu selection).

To begin the heating operation, the user may provide a “start” input via the control panel 120 (e.g., the user may depress a “start” button). In response, a host system controller (e.g., host/thermal system controller 252, 1252, FIGS. 2A, 2B) sends appropriate control signals to the thermal heating system 150 and/or the RF heating system 160 throughout the cooking process, depending on which cooking mode is being implemented.

When performing RF-only cooking or combined thermal and RF cooking, the system selectively activates and controls the RF heating system 150 in a manner in which maximum RF power transfer may be absorbed by the load contained within the food load container throughout the cooking process. During the heating operation, the impedance of the load (and thus the total input impedance of the cavity 110 plus load) changes as the thermal energy of the load increases. The impedance changes alter the absorption of RF energy into the load, and thus alter the magnitude of reflected power. According to an embodiment, power detection circuitry (e.g., power detection circuitry 230, 1230, FIGS. 2A, 2B) continuously or periodically measures the reflected power along a transmission path between the RF signal source and the system electrode(s) 170 and/or 172. Based on these measurements, an RF heating system controller (e.g., RF heating system controller 212, 1212, FIGS. 2A, 2B) may alter the state of the variable impedance matching network (e.g., networks 270, 1234, 1270, FIGS. 2A, 2B) during the heating operation to increase the absorption of RF power by the load. In addition, in some embodiments, the RF system controller may detect completion of the heating operation (e.g., when the load temperature has reached a target temperature) based on feedback from the power detection circuitry.

The heating system 100 of FIG. 1 is embodied as a counter-top type of appliance. Those of skill in the art would understand, based on the description herein, that embodiments of heating systems may be incorporated into systems or appliances having other configurations, as well. Accordingly, the above-described implementations of heating systems in a stand-alone appliance are not meant to limit use of the embodiments only to those types of systems. Instead, various embodiments of heating systems may be incorporated into wall-cavity installed appliances, and systems that include multiple types of appliances incorporated in a common housing.

Further, although heating system 100 is shown with its components in particular relative orientations with respect to one another, it should be understood that the various components may be oriented differently, as well. In addition, the physical configurations of the various components may be different. For example, control panel 120 may have more, fewer, or different user interface elements, and/or the user interface elements may be differently arranged. Further, although the electrodes 170, 172 are shown at the top and bottom cavity walls 111, 112, the electrodes 170, 172 may be located at opposed side walls, as well. In addition, although a substantially cubic heating cavity 110 is illustrated in FIG. 1, it should be understood that a heating cavity may have a different shape, in other embodiments (e.g., cylindrical, and so on). Further, heating system 100 may include additional components (e.g., a stationary or rotating plate within the cavity, an electrical cord, and so on) that are not specifically depicted in FIG. 1.

FIG. 2A is a simplified block diagram of an unbalanced heating system 200 (e.g., heating system 100 of FIG. 1), in accordance with an example embodiment. Heating system 200 includes host/thermal system controller 252, RF heating system 210, thermal heating system 250, user interface 292, and a containment structure 266 that defines a cavity 260, in an embodiment. It should be understood that FIG. 2A is a simplified representation of a heating system 200 for purposes of explanation and ease of description, and that practical embodiments may include other devices and components to provide additional functions and features, and/or the heating system 200 may be part of a larger electrical system.

The containment structure 266 may include bottom, top, and side walls, the interior surfaces of which define the cavity 260 (e.g., cavity 110, FIG. 1). According to an embodiment, the cavity 260 may be sealed (e.g., with a door) to contain the heat and electromagnetic energy that is introduced into the cavity 260 during a heating operation.

User interface 292 may correspond to a control panel (e.g., control panel 120, FIG. 1), for example, which enables a user to provide inputs to the system regarding parameters for a heating operation. In addition, the user interface may be configured to provide user-perceptible outputs indicating the status of a heating operation (e.g., a countdown timer, visible indicia indicating progress or completion of the heating operation, and/or audible tones indicating completion of the heating operation) and other information.

The thermal heating system 250 includes host/thermal system controller 252, one or more thermal heating components 254, and, in some embodiments, thermostat 256. In some embodiments, host/thermal system controller 252 and portions of user interface 292 may be included together in a host module 290.

Host/thermal system controller 252 is configured to receive signals indicating user inputs received via user interface 292, and to provide signals to the user interface 292 that enable the user interface 292 to produce user-perceptible outputs (e.g., via a display, speaker, and so on) indicating various aspects of the system operation. In addition, host/thermal system controller 252 sends control signals to other components of the thermal heating system 250 (e.g., to thermal heating components 254) to selectively activate, deactivate, and otherwise control those other components in accordance with desired system operation. The host/thermal system controller 252 also may receive signals from the thermal heating system components 254, thermostat 256, and sensors 294 (if included), indicating operational parameters of those components, and the host/thermal system controller 252 may modify operation of the system 200 accordingly, as will be described later. Further still, host/thermal system controller 252 receives signals from the RF heating system controller 212 regarding operation of the RF heating system 210. Responsive to the received signals and measurements from the user interface 292 and from the RF heating system controller 212, host/thermal system controller 252 may provide additional control signals to the RF heating system controller 212, which affects operation of the RF heating system 210.

The one or more thermal heating components 254 may include components that are configured to heat air within the cavity 260. The thermostat 256 is configured to sense the air temperature within the cavity 260, and to control operation of the one or more thermal heating components 254 to maintain the air temperature within the cavity at or near a temperature set point.

The RF heating system 210 includes RF heating system controller 212, RF signal source 220, power supply and bias circuitry 226, first impedance matching circuit 234 (herein “first matching circuit”), variable impedance matching network 270, first and second electrodes 240, 242, and power detection circuitry 230, in an embodiment. According to an embodiment, RF heating system controller 212 is coupled to host/thermal system controller 252, RF signal source 220, variable impedance matching network 270, power detection circuitry 230, and sensors 294 (if included). RF heating system controller 212 is configured to receive control signals from the host/thermal system controller 252 indicating various operational parameters, and to receive signals indicating RF signal reflected power (and possibly RF signal forward power) from power detection circuitry 230. Responsive to the received signals and measurements, RF heating system controller 212 provides control signals to the power supply and bias circuitry 226 and to the RF signal generator 222 of the RF signal source 220. In addition, RF heating system controller 212 provides control signals to the variable impedance matching network 270, which cause the network 270 to change its state or configuration.

Cavity 260 provides a capacitive heating arrangement with first and second parallel plate electrodes 240, 242 that are separated by an air cavity 260 within which a container 265 containing a load 264 to be heated may be placed. For example, a first electrode 240 may be positioned above the cavity 260, and a second electrode 242 may be positioned below the cavity 260. In other embodiments, a distinct second electrode 242 may be excluded, and the functionality of the second electrode may be provided by a portion of the containment structure 266 (i.e., the containment structure 266 may be considered to be the second electrode, in such an embodiment). According to an embodiment, the containment structure 266 and/or the second electrode 242 may be connected to a ground reference voltage (i.e., containment structure 266 and second electrode 242 are grounded). The first and second electrodes 240, 242 are positioned within containment structure 266 to define a distance 246 between the electrodes 240, 242, where the distance 246 renders the cavity 260 a sub-resonant cavity, in an embodiment.

In general, an RF heating system 210 designed for lower operational frequencies (e.g., frequencies between 10 MHz and 1 GHz) may be designed to have a distance 246 that is a smaller fraction of one wavelength. For example, when system 210 is designed to produce an RF signal with an operational frequency of about 10 MHz (corresponding to a wavelength of about 30 meters), and distance 246 is selected to be about 0.5 meters, the distance 246 is about one 60th of one wavelength of the RF signal. Conversely, when system 210 is designed for an operational frequency of about 300 MHz (corresponding to a wavelength of about 1 meter), and distance 246 is selected to be about 0.5 meters, the distance 246 is about one half of one wavelength of the RF signal.

With the operational frequency and the distance 246 between electrodes 240, 242 being selected to define a sub-resonant interior cavity 260, the first and second electrodes 240, 242 are capacitively coupled. More specifically, the first electrode 240 may be analogized to a first plate of a capacitor, the second electrode 242 may be analogized to a second plate of a capacitor, and the load 264, barrier 262 (if included), and air within the cavity 260 may be analogized to a capacitor dielectric. Accordingly, the first electrode 240 alternatively may be referred to herein as an “anode,” and the second electrode 242 may alternatively be referred to herein as a “cathode.”

Essentially, the voltage across the first electrode 240 and the second electrode 242 contributes to heating the load 264 within the cavity 260. According to various embodiments, the RF heating system 210 is configured to generate the RF signal to produce voltages between the electrodes 240, 242 in a range of about 20 volts to about 3,000 volts, in one embodiment, or in a range of about 3,000 volts to about 10,000 volts, in another embodiment, although the system 210 may be configured to produce lower or higher voltages between the electrodes 240, 242, as well.

The first electrode 240 is electrically coupled to the RF signal source 220 through a first matching circuit 234, a variable impedance matching network 270, and a conductive transmission path, in an embodiment. The first matching circuit 234 is configured to perform an impedance transformation from an impedance of the RF signal source 220 (e.g., less than about 10 ohms) to an intermediate impedance (e.g., 50 ohms, 75 ohms, or some other value). According to an embodiment, the conductive transmission path includes a plurality of conductors 228-1, 228-2, and 228-3 connected in series, and referred to collectively as transmission path 228. According to an embodiment, the conductive transmission path 228 is an “unbalanced” path, which is configured to carry an unbalanced RF signal (i.e., a single RF signal referenced against ground). In some embodiments, one or more connectors (not shown, but each having male and female connector portions) may be electrically coupled along the transmission path 228, and the portion of the transmission path 228 between the connectors may comprise a coaxial cable or other suitable connector.

The variable impedance matching circuit 270 is configured to perform an impedance transformation from the above-mentioned intermediate impedance to an input impedance of cavity 260 as modified by the load 264 (e.g., on the order of hundreds or thousands of ohms, such as about 1000 ohms to about 4000 ohms or more). In an embodiment, the variable impedance matching network 270 includes a network of passive components (e.g., inductors, capacitors, resistors).

According to an embodiment, RF signal source 220 includes an RF signal generator 222 and a power amplifier (e.g., including one or more power amplifier stages 224, 225). In response to control signals provided by RF heating system controller 212 over connection 214, RF signal generator 222 is configured to produce an oscillating electrical signal having a frequency in the ISM (industrial, scientific, and medical) band, although the system could be modified to support operations in other frequency bands, as well. The RF signal generator 222 may be controlled to produce oscillating signals of different power levels and/or different frequencies, in various embodiments. For example, the RF signal generator 222 may produce a signal that oscillates in the VHF (very high frequency) range (i.e., in a range between about 30 MHz and about 300 MHz), and/or in a range of about 1 MHz to about 100 MHz, and/or from about 100 MHz to about 3.0 gigahertz (GHz). Some desirable frequencies may be, for example, 13.56 MHz (+/− 5 percent), 27.125 MHz (+/− 5 percent), 40.68 MHz (+/− 5 percent), and 915 MHz (+/− 5 percent). In one particular embodiment, for example, the RF signal generator 222 may produce a signal that oscillates in a range of about 40.66 MHz to about 40.70 MHz and at a power level in a range of about 10 decibel-milliwatts (dBm) to about 15 dBm. Alternatively, the frequency of oscillation and/or the power level may be lower or higher.

In the embodiment of FIG. 2A, the power amplifier includes a driver amplifier stage 224 and a final amplifier stage 225. The power amplifier is configured to receive the oscillating signal from the RF signal generator 222, and to amplify the signal to produce a significantly higher-power signal at an output of the power amplifier. For example, the output signal may have a power level in a range of about 100 watts (W) to about 400 W or more. The gain applied by the power amplifier may be controlled using gate bias voltages and/or drain bias voltages provided by the power supply and bias circuitry 226 to each amplifier stage 224, 225. More specifically, power supply and bias circuitry 226 provides bias and supply voltages to each RF amplifier stage 224, 225 in accordance with control signals received from RF heating system controller 212.

In FIG. 2A, the power amplifier arrangement is depicted to include two amplifier stages 224, 225 coupled in a particular manner to other circuit components. In other embodiments, the power amplifier arrangement may include other amplifier topologies and/or the amplifier arrangement may include only one amplifier stage, or more than two amplifier stages. For example, the power amplifier arrangement may include various embodiments of a single-ended amplifier, a Doherty amplifier, a Switch Mode Power Amplifier (SMPA), or another type of amplifier.

Cavity 260 and any load 264 (e.g., grains, food, liquids, and so on) positioned in the cavity 260 in combination with container 265 present a cumulative load for the electromagnetic energy (or RF power) that is radiated into the cavity 260 by the first electrode 240. More specifically, the cavity 260 and the container 265 and load 264 present an impedance to the system, referred to herein as a “cavity plus load impedance.” The cavity plus load impedance changes during a heating operation as the temperature of the load 264 increases and the load 264 cooks. The cavity plus load impedance has a direct effect on the magnitude of reflected signal power along the conductive transmission path 228 between the RF signal source 220 and electrode 240. In most cases, it is desirable to maximize the magnitude of transferred signal power into the cavity 260, and/or to minimize the reflected-to-forward signal power ratio along the conductive transmission path 228.

In order to at least partially match the output impedance of the RF signal generator 220 to the cavity plus load impedance, a first matching circuit 234 is electrically coupled along the transmission path 228, in an embodiment. The first matching circuit 234 may have any of a variety of configurations. According to an embodiment, the first matching circuit 234 includes fixed components (i.e., components with non-variable component values), although the first matching circuit 234 may include one or more variable components, in other embodiments. For example, the first matching circuit 234 may include any one or more circuits selected from an inductance/capacitance (LC) network, a series inductance network, a shunt inductance network, or a combination of bandpass, high-pass and low-pass circuits, in various embodiments. Essentially, the fixed matching circuit 234 is configured to raise the impedance to an intermediate level between the output impedance of the RF signal generator 220 and the cavity plus load impedance.

According to an embodiment, power detection circuitry 230 is coupled along the transmission path 228 between the output of the RF signal source 220 and the electrode 240. In a specific embodiment, the power detection circuitry 230 forms a portion of the RF subsystem 210, and is coupled to the conductor 228-2 between the output of the first matching circuit 234 and the input to the variable impedance matching network 270. In alternate embodiments, the power detection circuitry 230 may be coupled to the portion 228-1 of the transmission path 228 between the output of the RF signal source 220 and the input to the first matching circuit 234, or to the portion 228-3 of the transmission path 228 between the output of the variable impedance matching network 270 and the first electrode 240.

Wherever it is coupled, power detection circuitry 230 is configured to monitor, measure, or otherwise detect the power of the reflected signals traveling along the transmission path 228 between the RF signal source 220 and electrode 240 (i.e., reflected RF signals traveling in a direction from electrode 240 toward RF signal source 220). In some embodiments, power detection circuitry 230 also is configured to detect the power of the forward signals traveling along the transmission path 228 between the RF signal source 220 and the electrode 240 (i.e., forward RF signals traveling in a direction from RF signal source 220 toward electrode 240). Over connection 232, power detection circuitry 230 supplies signals to RF heating system controller 212 conveying the magnitudes of the reflected signal power (and the forward signal power, in some embodiments). In embodiments in which both the forward and reflected signal power magnitudes are conveyed, RF heating system controller 212 may calculate a reflected-to-forward signal power ratio, or an S11 parameter, or a voltage standing wave ration (VSWR) value. As will be described in more detail below, when the reflected signal power magnitude exceeds a reflected signal power threshold, or when the reflected-to-forward signal power ratio exceeds an S11 parameter threshold, or when a VSWR value exceeds a VSWR threshold, this indicates that the system 200 is not adequately matched to the cavity plus load impedance, and that energy absorption by the load 264 within the cavity 260 may be sub-optimal. In such a situation, RF heating system controller 212 orchestrates a process of altering the state of the variable matching network 270 to drive the reflected signal power or the S11 parameter or the VSWR value toward or below a desired level (e.g., below the reflected signal power threshold, and/or the reflected-to-forward signal power ratio threshold, and/or the S11 parameter threshold, and/or the VSWR threshold), thus re-establishing an acceptable match and facilitating more optimal energy absorption by the load 264.

For example, the RF heating system controller 212 may provide control signals over control path 216 to the variable matching circuit 270, which cause the variable matching circuit 270 to vary inductive, capacitive, and/or resistive values of one or more components within the circuit, thus adjusting the impedance transformation provided by the circuit 270. Adjustment of the configuration of the variable matching circuit 270 desirably decreases the magnitude of reflected signal power, which corresponds to decreasing the magnitude of the S11 parameter and/or VSWR, and increasing the power absorbed by the load 264.

As discussed above, the variable impedance matching network 270 is used to match the cavity plus load impedance of the cavity 260 plus load 264 and container 265 to maximize, to the extent possible, the RF power transfer into the load 264. The initial impedance of the cavity 260, the load 264 and container 265 may not be known with accuracy at the beginning of a heating operation. Further, the impedance of the load 264 changes during a heating operation as the load 264 warms up. According to an embodiment, the RF heating system controller 212 may provide control signals to the variable impedance matching network 270, which cause modifications to the state of the variable impedance matching network 270. This enables the RF heating system controller 212 to establish an initial state of the variable impedance matching network 270 at the beginning of the heating operation that has a relatively low reflected to forward power ratio, and thus a relatively high absorption of the RF power by the load 264. In addition, this enables the RF heating system controller 212 to modify the state of the variable impedance matching network 270 so that an adequate match may be maintained throughout the heating operation, despite changes in the impedance of the load 264.

Some embodiments of heating system 200 may include temperature sensor(s), IR sensor(s), and/or weight sensor(s) 294. The temperature sensor(s) and/or IR sensor(s) may be positioned in locations that enable the temperature of the load 264 to be sensed during the heating operation. When provided to the host/thermal system controller 252 and/or the RF heating system controller 212, for example, the temperature information enables the host/thermal system controller 252 and/or the RF heating system controller 212 to alter the power of the thermal energy produced by the thermal heating components 254 and/or the RF signal supplied by the RF signal source 220 (e.g., by controlling the bias and/or supply voltages provided by the power supply and bias circuitry 226), and/or to determine when the heating operation should be terminated. In addition, the RF heating system controller 212 may use the temperature information to adjust the state of the variable impedance matching network 270. The weight sensor(s) may be positioned under the load 264 or the container 265 of the load 264, and are configured to provide an estimate of the weight and/or mass of the load 264 to the host/thermal system controller 252 and/or the RF heating system controller 212. The host/thermal system controller 252 and/or RF heating system controller 212 may use this information, for example, to determine an approximate duration for the heating operation. Further, the RF heating system controller 212 may use this information to determine a desired power level for the RF signal supplied by the RF signal source 220, and/or to determine an initial setting for the variable impedance matching network 270.

The description associated with FIG. 2A discusses, in detail, an “unbalanced” heating apparatus, in which an RF signal is applied to one electrode (e.g., electrode 240, FIG. 2A), and the other electrode (e.g., electrode 242 or the containment structure 266, FIG. 2A) is grounded. As mentioned above, an alternate embodiment of a heating apparatus comprises a “balanced” heating apparatus. In such an apparatus, balanced RF signals are provided to both electrodes (e.g., by a push-pull amplifier). Specifically, in a balanced apparatus, the variable matching subsystem 270 houses an apparatus configured to receive, at an input of the apparatus, an unbalanced RF signal from the RF signal source 220 over the unbalanced portion of the transmission path, to convert the unbalanced RF signal into two balanced RF signals (e.g., two RF signals having a phase difference between 120 and 340 degrees, such as about 180 degrees), and to produce the two balanced RF signals at two outputs of the apparatus. For example, the conversion apparatus may be a balun, in an embodiment. The balanced RF signals could then be conveyed over separate conductors to electrodes 240, 242.

In an alternate balanced embodiment, an alternate RF signal generator 220 may produce balanced RF signals on separate output conductors, which may be directly coupled via appropriate matching circuits to electrodes 240, 242. In such an embodiment, a balun may be excluded from the system 200.

For example, FIG. 2B is a simplified block diagram of a balanced heating system 1200 (e.g., heating system 100, FIG. 1), in accordance with an example embodiment. Heating system 1200 includes host/thermal system controller 1252, RF heating system 1210, thermal heating system 1250, user interface 1292, and a containment structure 1266 that defines a cavity 1260, in an embodiment. It should be understood that FIG. 2B is a simplified representation of a heating system 1200 for purposes of explanation and ease of description, and that practical embodiments may include other devices and components to provide additional functions and features, and/or the heating system 1200 may be part of a larger electrical system.

The containment structure 1266 may include bottom, top, and side walls, the interior surfaces of which define the cavity 1260 (e.g., cavity 110, FIG. 1). According to an embodiment, the cavity 1260 may be sealed (e.g., with a door 116, FIG. 1) to contain the heat and electromagnetic energy that is introduced into the cavity 1260 during a heating operation. The system 1200 may include one or more interlock mechanisms that ensure that the seal is intact during a heating operation. If one or more of the interlock mechanisms indicates that the seal is breached, the host/thermal system controller 1252 may cease the heating operation.

User interface 1292 may correspond to a control panel (e.g., control panel 120, FIG. 1), for example, which enables a user to provide inputs to the system regarding parameters for a heating operation (e.g., the cooking mode, characteristics of the load to be heated, and so on), start and cancel buttons, mechanical controls (e.g., a door/drawer open latch), and so on. In addition, the user interface may be configured to provide user-perceptible outputs indicating the status of a heating operation (e.g., a countdown timer, visible indicia indicating progress or completion of the heating operation, and/or audible tones indicating completion of the heating operation) and other information.

The host/thermal system controller 1252 may perform functions associated with the overall system 1200 (e.g., “host control functions”), and functions associated more particularly with the thermal heating system 1250 (e.g., “thermal system control functions”). Because, in an embodiment, the host control functions and the thermal system control functions may be performed by one hardware controller, the host/thermal system controller 1252 is shown as a dual-function controller. In alternate embodiments, the host controller and the thermal system controller may be distinct controllers that are communicatively coupled.

The thermal heating system 1250 includes host/thermal system controller 1252, one or more optional thermal heating components 1254, and an optional thermostat 1256. Host/thermal system controller 1252 may include one or more general purpose or special purpose processors (e.g., a microprocessor, microcontroller, ASIC, and so on), volatile and/or non-volatile memory (e.g., RAM, ROM, flash, various registers, and so on), one or more communication busses, and other components. According to an embodiment, host/thermal system controller 1252 is coupled to user interface 1292, RF heating system controller 1212, thermal heating components 1254, thermostat 1256, and sensors 1294 (if included). In some embodiments, host/thermal system controller 1252 and portions of user interface 1292 may be included together in a host module 1290.

Host/thermal system controller 1252 is configured to receive signals indicating user inputs received via user interface 1292, and to provide signals to the user interface 1292 that enable the user interface 1292 to produce user-perceptible outputs (e.g., via a display, speaker, and so on) indicating various aspects of the system operation. In addition, host/thermal system controller 1252 sends control signals to other components of the thermal heating system 1250 (e.g., to thermal heating components 1254) to selectively activate, deactivate, and otherwise control those other components in accordance with desired system operation. The host/thermal system controller 1252 also may receive signals from the thermal heating system components 1254, thermostat 1256, and sensors 1294 (if included), indicating operational parameters of those components, and the host/thermal system controller 1252 may modify operation of the system 1200 accordingly, as will be described later. Further still, host/thermal system controller 1252 receives signals from the RF heating system controller 1212 regarding operation of the RF heating system 1210. Responsive to the received signals and measurements from the user interface 1292 and from the RF heating system controller 1212, host/thermal system controller 1252 may provide additional control signals to the RF heating system controller 1212, which affects operation of the RF heating system 1210.

The one or more thermal heating components 1254 may include, for example, one or more heating elements within a convection system, one or more gas burners, and/or other components that are configured to heat air within the cavity 1260. The thermostat 1256 is configured to sense the air temperature within the cavity 1260, and to control operation of the one or more thermal heating components 1254 to maintain the air temperature within the cavity at or near a temperature setpoint (e.g., a temperature setpoint established by the user through the user interface 1292). This temperature control process may be performed by the thermostat 1256 in a closed loop system with the thermal heating components 1254, or the thermostat 1256 may communicate with the host/thermal system controller 1252, which also participates in controlling operation of the one or more thermal heating components 1254. In some embodiments, a fan may be included when the system 1200 includes a convection heating system and the fan can be selectively activated and deactivated to circulate the air within the cavity.

The RF subsystem 1210 includes an RF heating system controller 1212, an RF signal source 1220, a first impedance matching circuit 1234 (herein “first matching circuit”), power supply and bias circuitry 1226, and power detection circuitry 1230, in an embodiment. RF heating system controller 1212 may include one or more general purpose or special purpose processors (e.g., a microprocessor, microcontroller, ASIC, and so on), volatile and/or non-volatile memory (e.g., RAM, ROM, flash, various registers, and so on), one or more communication busses, and other components. According to an embodiment, RF heating system controller 1212 is coupled to host/thermal system controller 1252, RF signal source 1220, variable impedance matching network 1270, power detection circuitry 1230, and sensors 1294 (if included). RF heating system controller 1212 is configured to receive control signals from the host/thermal system controller 1252 indicating various operational parameters, and to receive signals indicating RF signal reflected power (and possibly RF signal forward power) from power detection circuitry 1230. Responsive to the received signals and measurements, and as will be described in more detail later, RF heating system controller 1212 provides control signals to the power supply and bias circuitry 1226 and to the RF signal generator 1222 of the RF signal source 1220. In addition, RF heating system controller 1212 provides control signals to the variable impedance matching network 1270, which cause the network 1270 to change its state or configuration.

Cavity 1260 includes a capacitive heating arrangement with first and second parallel plate electrodes 1240, 1242 that are separated by an air cavity 1260 within which a load 1264 to be heated may be placed. For example, a first electrode 1240 may be positioned above the air cavity 1260, and a second electrode 1242 may be positioned below the air cavity 1260. In some embodiments, the second electrode 1242 may be implemented in the form of a shelf or contained within a shelf that is inserted in the cavity 1260 as previously described. To avoid direct contact between the load 1264 and the second electrode 1242 (or the grounded bottom surface of the cavity 1260), a non-conductive barrier 1262 may be positioned over the second electrode 1242.

Again, cavity 1260 includes a capacitive heating arrangement with first and second parallel plate electrodes 1240, 1242 that are separated by an air cavity 1260 within which a load 1264 to be heated may be placed. The first and second electrodes 1240, 1242 are positioned within containment structure 1266 to define a distance 1246 between the electrodes 1240, 1242, where the distance 1246 renders the cavity 1260 a sub-resonant cavity, in an embodiment.

In general, an RF heating system 1210 designed for lower operational frequencies (e.g., frequencies between 10 MHz and 100 MHz) may be designed to have a distance 1246 that is a smaller fraction of one wavelength. For example, when system 1210 is designed to produce an RF signal with an operational frequency of about 10 MHz (corresponding to a wavelength of about 30 meters), and distance 1246 is selected to be about 0.5 meters, the distance 1246 is about one 60th of one wavelength of the RF signal. Conversely, when system 1210 is designed for an operational frequency of about 300 MHz (corresponding to a wavelength of about 1 meter), and distance 1246 is selected to be about 0.5 meters, the distance 1246 is about one half of one wavelength of the RF signal.

With the operational frequency and the distance 1246 between electrodes 1240, 1242 being selected to define a sub-resonant interior cavity 1260, the first and second electrodes 1240, 1242 are capacitively coupled. More specifically, the first electrode 1240 may be analogized to a first plate of a capacitor, the second electrode 1242 may be analogized to a second plate of a capacitor, and the load 1264, barrier 1262 (if included), and air within the cavity 1260 may be analogized to a capacitor dielectric. Accordingly, the first electrode 1240 alternatively may be referred to herein as an “anode,” and the second electrode 1242 may alternatively be referred to herein as a “cathode.”

Essentially, the voltage across the first electrode 1240 and the second electrode 1242 contributes to heating the load 1264 within the cavity 1260. According to various embodiments, the RF heating system 1210 is configured to generate the RF signal to produce voltages between the electrodes 1240, 1242 in a range of about 20 volts to about 3,000 volts, in one embodiment, or in a range of about 3,000 volts to about 10,000 volts, in another embodiment, although the system 1210 may be configured to produce lower or higher voltages between the electrodes 1240, 1242, as well.

An output of the RF subsystem 1210, and more particularly an output of RF signal source 1220, is electrically coupled to the variable matching subsystem 1270 through a conductive transmission path, which includes a plurality of conductors 1228-1, 1228-2, 1228-3, 1228-4, and 1228-5 connected in series, and referred to collectively as transmission path 1228. According to an embodiment, the conductive transmission path 1228 includes an “unbalanced” portion and a “balanced” portion, where the “unbalanced” portion is configured to carry an unbalanced RF signal (i.e., a single RF signal referenced against ground), and the “balanced” portion is configured to carry a balanced RF signal (i.e., two signals referenced against each other). The “unbalanced” portion of the transmission path 1228 may include unbalanced first and second conductors 1228-1, 1228-2 within the RF subsystem 1210, one or more connectors 1236, 1238 (each having male and female connector portions), and an unbalanced third conductor 1228-3 electrically coupled between connectors 1236, 1238. According to an embodiment, the third conductor 1228-3 comprises a coaxial cable, although the electrical length may be shorter or longer, as well. In an alternate embodiment, the variable matching subsystem 1270 may be housed with the RF subsystem 1210, and in such an embodiment, the conductive transmission path 1228 may exclude the connectors 1236, 1238 and the third conductor 1228-3. Either way, the “balanced” portion of the conductive transmission path 1228 includes a balanced fourth conductor 1228-4 within the variable matching subsystem 1270, and a balanced fifth conductor 1228-5 electrically coupled between the variable matching subsystem 1270 and electrodes 1240, 1242, in an embodiment.

As indicated in FIG. 2B, the variable matching subsystem 1270 houses an apparatus configured to receive, at an input of the apparatus, the unbalanced RF signal from the RF signal source 1220 over the unbalanced portion of the transmission path (i.e., the portion that includes unbalanced conductors 1228-1, 1228-2, and 1228-3), to convert the unbalanced RF signal into two balanced RF signals (e.g., two RF signals having a phase difference between 120 and 340 degrees, such as about 180 degrees), and to produce the two balanced RF signals at two outputs of the apparatus. For example, the conversion apparatus may be a balun 1274, in an embodiment. The balanced RF signals are conveyed over balanced conductors 1228-4 to the variable matching circuit 1272 and, ultimately, over balanced conductors 1228-5 to the electrodes 1240, 1242. In an embodiments, balanced conductors 1228-5 are first and second outputs of RF subsystem 1210 in which RF subsystem 1210 is an RF signal source of device 1200.

In an alternate embodiment, as indicated in a dashed box in the center of FIG. 2B, and as will be discussed in more detail below, an alternate RF signal generator 1220′ may produce balanced RF signals on balanced conductors 1228-1′, which may be directly coupled to the variable matching circuit 1272 (or coupled through various intermediate conductors and connectors). In such an embodiment, the balun 1274 may be excluded from the system 1200. Either way, a double-ended variable matching circuit 1272 is configured to receive the balanced RF signals (e.g., over connections 1228-4 or 1228-1′), to perform an impedance transformation corresponding to a then-current configuration of the double-ended variable matching circuit 1272, and to provide the balanced RF signals to the first and second electrodes 1240, 1242 over connections 1228-5.

According to an embodiment, RF signal source 1220 includes an RF signal generator 1222 and a power amplifier 1224 (e.g., including one or more power amplifier stages). In response to control signals provided by RF heating system controller 1212 over connection 1214, RF signal generator 1222 is configured to produce an oscillating electrical signal having a frequency in an ISM (industrial, scientific, and medical) band, although the system could be modified to support operations in other frequency bands, as well. The RF signal generator 1222 may be controlled to produce oscillating signals of different power levels and/or different frequencies, in various embodiments. For example, the RF signal generator 1222 may produce a signal that oscillates in the VHF range (i.e., in a range between about 30.0 MHz and about 300 MHz), and/or in a range of about 10.0 MHz to about 100 MHz and/or in a range of about 100 MHz to about 3.0 GHz. Some desirable frequencies may be, for example, 13.56 MHz (+/− 12 percent), 27.125 MHz (+/− 12 percent), 40.68 MHz (+/− 12 percent), and 915 MHz (+/− 12 percent). Alternatively, the frequency of oscillation may be lower or higher than the above-given ranges or values.

The power amplifier 1224 is configured to receive the oscillating signal from the RF signal generator 1222, and to amplify the signal to produce a significantly higher-power signal at an output of the power amplifier 1224. For example, the output signal may have a power level in a range of about 100 W to about 400 W or more, although the power level may be lower or higher, as well. The gain applied by the power amplifier 1224 may be controlled using gate bias voltages and/or drain bias voltages provided by the power supply and bias circuitry 1226 to one or more stages of amplifier 1224. More specifically, power supply and bias circuitry 1226 provides bias and supply voltages to the inputs and/or outputs (e.g., gates and/or drains) of each RF amplifier stage in accordance with control signals received from RF heating system controller 1212.

The power amplifier may include one or more amplification stages. In an embodiment, each stage of amplifier 1224 is implemented as a power transistor, such as a FET, having an input terminal (e.g., a gate or control terminal) and two current carrying terminals (e.g., source and drain terminals). Impedance matching circuits (not illustrated) may be coupled to the input (e.g., gate) and/or output (e.g., drain terminal) of some or all of the amplifier stages, in various embodiments. In an embodiment, each transistor of the amplifier stages includes an LDMOS FET. However, it should be noted that the transistors are not intended to be limited to any particular semiconductor technology, and in other embodiments, each transistor may be realized as a GaN transistor, another type of MOS FET transistor, a BJT, or a transistor utilizing another semiconductor technology.

In FIG. 2B, the power amplifier arrangement 1224 is depicted to include one amplifier stage coupled in a particular manner to other circuit components. In other embodiments, the power amplifier arrangement 1224 may include other amplifier topologies and/or the amplifier arrangement may include two or more amplifier stages. For example, the power amplifier arrangement may include various embodiments of a single-ended amplifier, a double-ended (balanced) amplifier, a push-pull amplifier, a Doherty amplifier, an SMPA, or another type of amplifier.

For example, as indicated in the dashed box in the center of FIG. 2B, an alternate RF signal generator 1220′ may include a push-pull or balanced amplifier 1224′, which is configured to receive, at an input, an unbalanced RF signal from the RF signal generator 1222, to amplify the unbalanced RF signal, and to produce two balanced RF signals at two outputs of the amplifier 1224′, where the two balanced RF signals are thereafter conveyed over conductors 1228-1′ to the electrodes 1240, 1242. In such an embodiment, the balun 1274 may be excluded from the system 1200, and the conductors 1228-1′ may be directly connected to the variable matching circuit 1272 (or connected through multiple coaxial cables and connectors or other multi-conductor structures).

Cavity 1260 and any load 1264 (e.g., grains, food, liquids, and so on) positioned in the cavity 1260 present a cumulative load for the electromagnetic energy (or RF power) that is radiated into the cavity 1260 by the electrodes 1240, 1242. More specifically, and as described previously, the cavity 1260 and the load 1264 present an impedance to the system, referred to herein as a “cavity plus load impedance.” The cavity plus load impedance changes during a heating operation as the temperature of the load 1264 increases. The cavity plus load impedance has a direct effect on the magnitude of reflected signal power along the conductive transmission path 1228 between the RF signal source 1220 and the electrodes 1240, 1242. In most cases, it is desirable to maximize the magnitude of transferred signal power into the cavity 1260, and/or to minimize the reflected-to-forward signal power ratio along the conductive transmission path 1228.

In order to at least partially match the output impedance of the RF signal generator 1220 to the cavity plus load impedance, a first matching circuit 1234 is electrically coupled along the transmission path 1228, in an embodiment. The first matching circuit 1234 is configured to perform an impedance transformation from an impedance of the RF signal source 1220 (e.g., less than about 10 ohms) to an intermediate impedance (e.g., 120 ohms, 75 ohms, or some other value). The first matching circuit 1234 may have any of a variety of configurations. According to an embodiment, the first matching circuit 1234 includes fixed components (i.e., components with non-variable component values), although the first matching circuit 1234 may include one or more variable components, in other embodiments. For example, the first matching circuit 1234 may include any one or more circuits selected from an inductance/capacitance (LC) network, a series inductance network, a shunt inductance network, or a combination of bandpass, high-pass and low-pass circuits, in various embodiments. Essentially, the first matching circuit 1234 is configured to raise the impedance to an intermediate level between the output impedance of the RF signal generator 1220 and the cavity plus load impedance.

According to an embodiment, and as mentioned above, power detection circuitry 1230 is coupled along the transmission path 1228 between the output of the RF signal source 1220 and the electrodes 1240, 1242. In a specific embodiment, the power detection circuitry 1230 forms a portion of the RF subsystem 1210, and is coupled to the conductor 1228-2 between the RF signal source 1220 and connector 1236. In alternate embodiments, the power detection circuitry 1230 may be coupled to any other portion of the transmission path 1228, such as to conductor 1228-1, to conductor 1228-3, to conductor 1228-4 between the RF signal source 1220 (or balun 1274) and the variable matching circuit 1272 (i.e., as indicated with power detection circuitry 1230′), or to conductor 1228-5 between the variable matching circuit 1272 and the electrode(s) 1240, 1242 (i.e., as indicated with power detection circuitry 1230″). For purposes of brevity, the power detection circuitry is referred to herein with reference number 1230, although the circuitry may be positioned in other locations, as indicated by reference numbers 1230′ and 1230″.

Wherever it is coupled, power detection circuitry 1230 is configured to monitor, measure, or otherwise detect the power of the reflected signals traveling along the transmission path 1228 between the RF signal source 1220 and one or both of the electrode(s) 1240, 1242 (i.e., reflected RF signals traveling in a direction from electrode(s) 1240, 1242 toward RF signal source 1220). In some embodiments, power detection circuitry 1230 also is configured to detect the power of the forward signals traveling along the transmission path 1228 between the RF signal source 1220 and the electrode(s) 1240, 1242 (i.e., forward RF signals traveling in a direction from RF signal source 1220 toward electrode(s) 1240, 1242).

Over connection 1232, power detection circuitry 1230 supplies signals to RF heating system controller 1212 conveying the measured magnitudes of the reflected signal power, and in some embodiments, also the measured magnitude of the forward signal power. In embodiments in which both the forward and reflected signal power magnitudes are conveyed, RF heating system controller 1212 may calculate a reflected-to-forward signal power ratio, or the S11 parameter, and/or a VSWR value. As will be described in more detail below, when the reflected signal power magnitude exceeds a reflected signal power threshold, or when the reflected-to-forward signal power ratio exceeds an S11 parameter threshold, or when the VSWR value exceeds a VSWR threshold, this indicates that the system 1200 is not adequately matched to the cavity plus load impedance, and that energy absorption by the load 1264 within the cavity 1260 may be sub-optimal. In such a situation, RF heating system controller 1212 may orchestrate a process of altering the state of the variable matching circuit 1272 to drive the reflected signal power or the S11 parameter or the VSWR value toward or below a desired level (e.g., below the reflected signal power threshold, and/or the reflected-to-forward signal power ratio threshold, and/or the VSWR threshold), thus re-establishing an acceptable match and facilitating more optimal energy absorption by the load 1264.

More specifically, the system controller 1212 may provide control signals over control path 1216 to the variable matching circuit 1272, which cause the variable matching circuit 1272 to vary inductive, capacitive, and/or resistive values of one or more components within the circuit, thus adjusting the impedance transformation provided by the circuit 1272. Adjustment of the configuration of the variable matching circuit 1272 desirably decreases the magnitude of reflected signal power, which corresponds to decreasing the magnitude of the S11 parameter and/or the VSWR value, and increasing the power absorbed by the load 1264.

As discussed above, the variable matching circuit 1272 is used to match the input impedance of the cavity 1260 plus load 1264 to maximize, to the extent possible, the RF power transfer into the load 1264. The initial impedance of the cavity 1260 and the load 1264 may not be known with accuracy at the beginning of a heating operation. Further, the impedance of the load 1264 changes during a heating operation as the load 1264 warms up. According to an embodiment, the system controller 1212 may provide control signals to the variable matching circuit 1272, which cause modifications to the state of the variable matching circuit 1272. This enables the system controller 1212 to establish an initial state of the variable matching circuit 1272 at the beginning of the heating operation that has a relatively low reflected to forward power ratio, and thus a relatively high absorption of the RF power by the load 1264. In addition, this enables the system controller 1212 to modify the state of the variable matching circuit 1272 so that an adequate match may be maintained throughout the heating operation, despite changes in the impedance of the load 1264.

The variable matching circuit 1272 may have any of a variety of configurations. For example, the circuit 1272 may include any one or more circuits selected from an inductance/capacitance (LC) network, an inductance-only network, a capacitance-only network, or a combination of bandpass, high-pass and low-pass circuits, in various embodiments. In an embodiment in which the variable matching circuit 1272 is implemented in a balanced portion of the transmission path 1228, the variable matching circuit 1272 is a double-ended circuit with two inputs and two outputs. In an alternate embodiment in which the variable matching circuit is implemented in an unbalanced portion of the transmission path 1228, the variable matching circuit may be a single-ended circuit with a single input and a single output. According to a more specific embodiment, the variable matching circuit 1272 includes a variable inductance network. According to another more specific embodiment, the variable matching circuit 1272 includes a variable capacitance network. In still other embodiments, the variable matching circuit 1272 may include both variable inductance and variable capacitance elements. The inductance, capacitance, and/or resistance values provided by the variable matching circuit 1272, which in turn affect the impedance transformation provided by the circuit 1272, are established through control signals from the RF heating system controller 1212, as will be described in more detail later. In any event, by changing the state of the variable matching circuit 1272 over the course of a heating operation to dynamically match the ever-changing impedance of the cavity 1260 plus the load 1264 within the cavity 1260, the system efficiency may be maintained at a high level throughout the heating operation.

Some embodiments of heating system 1200 may include temperature sensor(s), IR sensor(s), and/or weight sensor(s) 1294. The temperature sensor(s) and/or IR sensor(s) may be positioned in locations that enable the temperature of the load 1264 to be sensed during the heating operation. When provided to the host/thermal system controller 1252 and/or the RF heating system controller 1212, for example, the temperature information enables the host/thermal system controller 1252 and/or the RF heating system controller 1212 to alter the power of the thermal energy produced by the thermal heating components 1254 and/or the RF signal supplied by the RF signal source 1220 (e.g., by controlling the bias and/or supply voltages provided by the power supply and bias circuitry 1226), and/or to determine when the heating operation should be terminated. In addition, the RF heating system controller 1212 may use the temperature information to adjust the state of the variable impedance matching network 1270. The weight sensor(s) are positioned under the load 1264, and are configured to provide an estimate of the weight and/or mass of the load 1264 to the host/thermal system controller 1252 and/or the RF heating system controller 1212. The host/thermal system controller 1252 and/or RF heating system controller 1212 may use this information, for example, to determine an approximate duration for the heating operation. Further, the RF heating system controller 1212 may use this information to determine a desired power level for the RF signal supplied by the RF signal source 1220, and/or to determine an initial setting for the variable impedance matching network 1270.

According to various embodiments, the circuitry associated with the single-ended or double-ended variable impedance matching networks discussed herein may be implemented in the form of one or more modules, where a “module” is defined herein as an assembly of electrical components coupled to a common substrate (e.g., a printed circuit board (PCB) or other substrate). In addition, as mentioned previously, the host/thermal system controller (e.g., controller 252, 1252, FIGS. 2A, 2B) and portions of the user interface (e.g., user interface 292, 1292, FIGS. 2A, 2B) may be implemented in the form of a host module (e.g., host module 290, 1290, FIGS. 2A, 2B). Further still, in various embodiments, the circuitry associated with the processing and RF signal generation portions of the RF heating system (e.g., RF heating system 210, 1210, FIGS. 2A, 2B) also may be implemented in the form of one or more modules.

In the present disclosure, a heating system is configured to cook a food load, such as grain (e.g., corn), using RF energy. The system may use solid state amplifiers at relatively low frequencies (e.g., from about 1 MHz to about 1 GHz) as compared to conventional microwave technologies to generate the RF energy that is applied to a heating cavity of the system. The heating cavity may be relatively compact, as described below, and sized to fit a container containing the food load. Such a design may enable relatively high field strength to be generated within the food load enabling relatively quick heating and cooking of the food load. Additionally, the relatively high field strength enables cooking of the food load using lower power levels (e.g., up to or around 300 W) as compared to conventional food cooking systems, while maintaining reasonable cooking durations. Furthermore, the relatively low frequency RF energy used in the present cooking system may be more effective at cooking particular types of food, such as grains or kernels, in which the RF energy results in more uniform energy distribution through the kernels resulting in a better cooking process.

As described herein, the heating cavity of the present system (and any container containing a food load within the cavity) may be configured so that when the food load is cooked, the food load automatically exits the cavity. For example, in embodiments in which the heating system is used to cook corn, each piece of popcorn, once popped, may exit both the container containing the uncooked corn and the heating cavity upon popping. Such an arrangement would allow for kernels to pop and exit the heating cavity without being burned or over-cooked.

FIG. 3 is a diagram depicting some of the functional components of an embodiment of the present heating system. System 300 is configured to deliver RF energy into a heating cavity 302 to heat or cook a food load disposed therein. In an embodiment, system 300 is configured to cook a grain-based food load (e.g., corn kernels) that are contained within a container 304 (e.g., container 265) within the heating cavity 302 (e.g., cavity 260). Additionally, both the container 304 and heating cavity 306 may be configured so that when the food load contained within the container 304 is cooked, the cooked food (e.g., popped corn) exits both the container 304 and heating cavity 302. As such, the food load, once cooked, will not continue cooking within the heating cavity 302.

To define the heating cavity, system 300 includes an enclosure 306 (e.g., containment structure 266). Enclosure 306 may be fabricating using any suitable materials for providing the structure of enclosure 306 and sufficient mechanical support to system 300 components disposed within enclosure 306 or mounted to enclosure 306. In an embodiment, enclosure 306 includes a metal, such as aluminum or steel, fabricated to include top, bottom, left, right, and back walls of enclosure 306 (e.g., walls 111, 112, 113, 114, 115). A door 308 (e.g., door 116, FIG. 1) is moveably mounted to enclosure 306 and configured to swing open, allowing access to an interior volume of enclosure 306, or swing closed to close enclosure 306. When closed, one or more latching systems may be engaged between enclosure 306 and door 308 to securely fasten door 308 against enclosure 306 in the door's closed position.

Electrode 310 (e.g., electrode 170, 240) and electrode 312 (e.g., electrode 172, 242) are positioned within an interior volume of enclosure 306. Electrodes 310 and 312 each include a conductive material and are configured to radiate RF energy into an interior portion of enclosure 306. The embodiment depicted in FIG. 3 may be referred to as a “balanced” heating system 300 in which the RF signal is applied across the two electrodes 310, 312 in a push-pull arrangement. For example, the RF signal may include first and second RF signals applied to the first and second electrodes 310, 312, respectively, that may be substantially the same, but offset by a phase shift in a range of about 120-240 degrees, such as about 180 degrees. In other embodiments, however, system 300 may be implemented in an “unbalanced” configuration, in which an RF signal is applied to a single electrode (e.g., electrode 310) and the other electrode (e.g., electrode 312) is grounded. Alternatively, the unbalanced configuration may be implemented without the second electrode 312 in which the RF signal is applied directly to electrode 310 and the enclosure 306 is instead grounded. Accordingly, in the present heating system 300, electrode 312 may be considered optional as the function provided by electrode 312 may be provided by portions (or the entirety of) enclosure 306 and door 308, depending on the configuration of the amplifier system supplying the RF signal to electrode 310.

The view depicting enclosure 306 and electrodes 310 and 312 is a cross-sectional view. As described below, electrode 312 includes a number of holes or openings 318. The view of electrode 312 depicted in FIG. 3 is a cross-section taken through a number of the openings 318. As shown the various holes 318 formed in electrode 312 extend through the electrode 312 from a first surface of electrode 312 (e.g., the top surface) to a second surface of electrode 312 (e.g., the bottom surface).

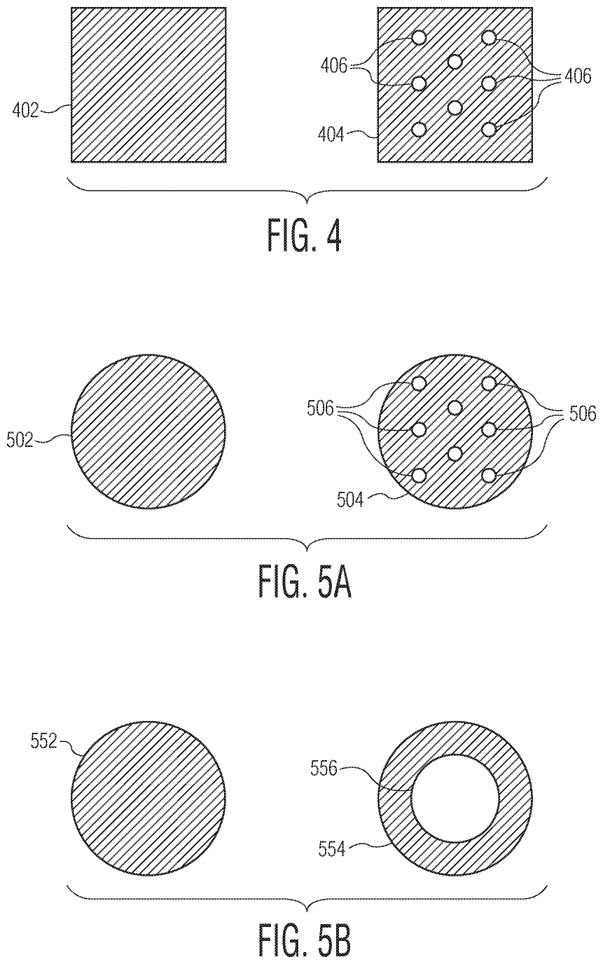

Electrodes 310 and 312 are generally of similar shape and construction, in an embodiment, with differences described below. As such, the outer perimeter of each of electrodes 310 and 312 (e.g., as shown in FIGS. 4, 5A, and 5B) may have the same approximate shape and electrodes 310 and 312 may have the same approximate thickness. For example, in an embodiment, electrodes 310 and 312 may be circular in shape (e.g., as shown in FIGS. 5A and 5B), with diameters of approximately 12.5 centimeters (cm) (e.g., about 5 inches). In such a circular configuration, however, for typical applications, electrodes 310 and 312 may have diameters ranging from about 7.5 cm to about 25.5 cm, though different sizes may be used. In some embodiments, regardless of their shape, electrodes 310 and 312 may be configured to have surface areas ranging from 25 cm² to 650 cm², though in some embodiments, electrodes having smaller or larger surface areas may be used. In the example of FIG. 3, electrodes 310 and 312 have thicknesses ranging from about 10 millimeters (mm) to about 60 mm. Depending on the application, though, electrodes 310 and 312 may be fabricated with different ranges of thickness.

Generally, electrodes 310 and 312 may have any shape and in various embodiments may be square (e.g., as in FIG. 4), circular (e.g., as in FIGS. 5A and 5B), triangular, or have other perimeter shapes. Electrodes 310 and 312 are disposed within enclosure 306 in positions so that electrodes 310 and 312 are generally parallel to one another and separated by a distance 346. The separation of electrodes 310 and 312 enable a food load 314 to be positioned between electrodes 310 and 312 so that RF energy emitted by electrode 310 and/or 312 heats the food load. In this configuration, the electrodes 310 and 312 in combination with the food load 314 form a capacitive heating system, in that the two electrodes function as electrodes (or plates) of a capacitor, and the capacitor dielectric essentially includes the portion of the cavity between the two electrodes and any food load (e.g., grains, kernels, or other food material) contained therein. As RF energy is delivered into the dielectric (i.e., cavity and food load 314) by electrodes 310, 312, the food load 314 warms and cooks.

In an embodiment, heating system 300 is used to cook a food load including grains (e.g., corn kernels). In such an embodiment, the food load 314 may optionally be contained within a container 304 when food load 314 is positioned within enclosure 306. In some embodiments, the electrodes 310, 312 may be physically connected to and form a part of the container 304, while in other embodiments, the container 304 may be a physically distinct structure that is placed between the electrodes 310, 312 prior to a cooking operation. Container 304 may include any suitable materials (e.g., microwave-safe materials), such as polypropylenes, polymethylpentene, polysulfone, PTFE, or combinations thereof. In addition to the specific food load 314 to be cooked, container 304 may include other materials, such as flavorings, preservatives, or oils and/or fats that may enhance the flavor or cooking process for the food load 314. Container 304 may be configured to engage with structures inside enclosure 306 (e.g., retention structures 130 of FIG. 1) to ensure that container 304 is optimally positioned between electrodes 310 and 312 when disposed within enclosure 306.

Depending on the food load 314 to be cooked (and, particularly, the volume of the food load 314 to be cooked), electrode 310 and 312 may be separated by an optimal distance to most efficiently transfer RF energy into the food load. In some cases, electrodes 310 and 312 may be positioned to be as close to one another as possible, while still allowing container 304 to be positioned between electrodes 310 and 312. In that case, electrodes 310 and 312 may frictionally engage the container 304 when the container is inserted into heating cavity 302 between electrodes 310 and 312.

Generally, heating cavity defined by enclosure 306 and electrodes 310, 312 is relatively small to enable a strong electromagnetic field to be formed across electrodes 310, 312. As such, the distance between electrodes 310, 312 may be small. In some cases, the distance separating electrodes 310, 312 may be not significantly greater than the diameter of the grain kernels being cooked (e.g., approximately 1 cm). In typical applications, however, the separation distance between electrodes 310, 312 may range from about 1 cm to about 6 cm, or greater. When cooking grains, the grains may be arranged in a single layer (e.g., a single layer of corn kernels) between electrodes 310, 312. Or, if the distance between electrodes 310, 312 is sufficiently large, the grains may be arranged in multiple layers between electrodes 310, 312. If cooked within container 304, the grains may be arranged in one or more layers within the container 304. When the food load includes corn kernels to be cooked into popcorn, a typical volume of the food load (e.g., to generate approximately a single serving of popcorn of 2 to 5 cups) may be from about 0.07 to about 0.18 cups of uncooked kernels (e.g., the volume of food load may be about 16 cm³ to about 43 cm³, although it may be smaller or greater, as well).

System 300 (and, specifically, container 304, electrode 312, and enclosure 306) may be configured so that when the food load 314 is cooked, the food load 314 exits the enclosure 306 so as to avoid being overcooked, and to be made available for a consumer as quickly as possible following cooking of the food load 314.

For example, when the food load 314 is a grain (e.g., corn kernel) that expands significantly upon being cooked (e.g., via being puffed up or “popped”), container 304 may be configured to allow the popped corn to exit container 304. Any suitable mechanism may be used to facilitate the popped corn exiting container 304. For example, portions of container 304 may be configured to tear or be pushed open when a kernel has popped within container 304 enabling the popped kernel to exit the container 304. For example, each kernel within container 304 may be housed within its own frangible cell within container 304. As each kernel in such a container 304 pops, the popped kernel could be ejected out of the container 304 due to the expansion in volume of the popped kernel and the fracturing, breaking, or tearing of the kernel's frangible cell. As such, container 304 may have a number of predetermined locations (e.g., cooked food exit regions 369) from which cooked food (e.g., popped corn) will exit the container 304. According to various embodiments, for example, the frangible portions of container 304 (e.g., the bottom surface of container 304 in FIG. 3, or a frangible portion of a cell) may be formed from aluminum (coated or otherwise), coated paper (e.g., a wax paper), card board, frangible plastics, or other materials that are suitable for food containment during application of RF energy.

To facilitate cooked food exiting enclosure 306, electrode 312 may be fabricated with a number of holes or openings 318 that are sized to let the cooked food pass through electrode 312, while still having sufficient area to radiate electromagnetic energy in response to the RF signals provided to the electrode 312. Due to the relatively-low frequency of the RF energy conveyed by electrodes 310 and 312, the holes or openings formed in electrode 312 to enable food to pass therethrough may be relatively large and adequate to enable, for example, popcorn to pass therethrough. For example, at operational frequencies ranging from 1 MHz-300 Mhz, holes formed in electrode 312 should be sized so as not to affect the electromagnetic energy radiated by the electrode 312. Unless the holes are very large (e.g., greater than 10 cm), the electrode 312, even with holes, acts as a solid electrode when radiating the RF energy. Generally, electrode 312 may include holes having diameters less than 1/10 the wavelength of the RF energy by emitted by the electrode 312. At operational frequencies ranging up to 300 MHz, for example, the holes may have a maximum diameter of 0.1 meter (i.e., 10 cm). In embodiments in which the operational frequency may reach up to about 1 GHz, the holes may have a diameter up to about 3 cm without significantly affecting the performance of system 300 or the strength of the RF energy emitted by the combination of electrodes 310 and 312.

To illustrate, FIGS. 4, 5A, and 5B depict example electrodes that may be utilized within system 300. In FIG. 4, electrode 402 may be used as electrode 310 of FIG. 3, while electrode 404 may be used as electrode 312 of FIG. 3. Electrodes 402 and 404 generally have a square or rectangular outer perimeter and a surface area ranging from about 25 cm² to about 650 cm², although they may be smaller or larger, as well. Both electrodes 402 and 404 have similar geometrical construction, however electrode 404, being optionally used to implement electrode 312 of FIG. 3, includes a number of openings 406. Openings 406 are sized to enable cooked food to pass through the openings 406 and, thereby, through electrode 404. In an embodiment, the openings 406 are located within electrode 404 to overlap or be positioned directly underneath regions of a container (e.g., cooked food exit points 369 of container 304) from which cooked food will exit. Openings 406 formed in electrode 404 extend through the electrode 404 from a first surface of electrode 404 to a second surface of electrode 404.

In FIG. 5A, electrode 502 may be used as electrode 310 of FIG. 3, while electrode 504 may be used as electrode 312 of FIG. 3. Electrodes 502 and 504 generally have a circular or rounded outer perimeter and a surface area ranging from about 25 cm² to about 650 cm², although they may be smaller or larger, as well. Both electrodes 502 and 504 have similar geometrical construction, however electrode 504, being optionally used to implement electrode 312 of FIG. 3, includes a number of openings 506. Openings 506 are sized to enable cooked food to pass through the openings 506 and, thereby, through electrode 504. In an embodiment, the openings 506 are located within electrode 504 to overlap regions of a container (e.g., container 304) from which cooked food will exit. Openings 506 formed in electrode 504 extend through the electrode 504 from a first surface of electrode 504 to a second surface of electrode 504.

In FIG. 5B, electrode 552 may be used as electrode 310 of FIG. 3, while electrode 554 may be used as electrode 312 of FIG. 3. Electrodes 552 and 554 generally have a circular or rounded outer perimeter. Both electrodes 552 and 554 have similar geometrical construction, however electrode 554, being optionally used to implement electrode 312 of FIG. 3, includes a central opening 556. In this configuration, electrode 554 is a ring electrode. The diameter of opening 556 may be limited by the maximum frequency of the RF energy that electrode 554 is anticipated to radiate in the heating appliance. In an embodiment, the diameter of the opening 556 is equal to or less than 1/10 of the maximum frequency of the RF signal that will be applied to electrode 554. So, when the maximum frequency of the heating appliance is about 300 MHz, the diameter of opening 556 may be equal to or less than 10 cm. In other embodiments, the diameter of central opening 556 may range from about 6 cm to about 10 cm, for example, though in different applications different sizes of central opening 556 may be incorporated into electrode 554. In this configuration, opening 556 may be configured to overlap the portion of a container (e.g., container 304) from which cooked food will exit. Opening 556 formed in electrode 554 extends through the electrode 554 from a first surface of electrode 554 to a second surface of electrode 554.

Returning to FIG. 3, enclosure 306 includes an opening 320 to let cooked food exit the enclosure 306. Accordingly, as food is cooked within enclosure 306, the cooked food (e.g., popped corn kernels) exits container 304, passes through the openings 318 in electrode 312 and out of enclosure 306 through opening 320. The cooked food can then be captured (e.g., within a bowl or other receptacle) and consumed.

In FIG. 3, electrodes 310 and 312 are depicted as each being parallel to the top and bottom surfaces of enclosure 306. In other embodiments, however, electrodes 310 and 312 may be rearranged so that the electrodes are instead are parallel to opposed sidewalls of enclosure 306. As such, electrodes 310 and 312 could be positioned along the sides of heating cavity 302. In that case, neither electrode 310 nor electrode 312 may require holes or openings, as cooked food would not be required to pass through either electrode 310 or 312 in such an arrangement.

System 300 includes an RF signal source 322 (e.g., RF signal source 220, FIG. 2A) configured to output an RF signal. RF signal source is connected to electrode 310 and 312 through a variable impedance matching network 324 (e.g., one or more of matching circuit 234 and variable impedance matching network 270). According to an embodiment, variable impedance matching network 324 is configured to convert an RF signal received from RF signal source 322 into a balanced signal (i.e., first and second RF signals that are out of phase with each other, as described previously), and the first and second signal components of the balanced signal are conveyed to electrodes 310 and 312 via transmission paths 326 and 328. Variable impedance matching network 324 also is configured to perform an impedance transformation from an impedance of the RF signal source 322 to an input impedance of the enclosure 306, as modified by the food load 314 and container 304. In an embodiment, the variable impedance matching network 324 includes a network of passive components (e.g., inductors, capacitors, resistors) that can be connected to one another in various configurations to achieve a desired impedance transformation. Generally, however, variable impedance matching network 324 may utilize any combination of components, such as variable capacitors, switching capacitors and/or inductors, and the like, to achieve the desired impedance transformation.

According to an embodiment, RF signal source 322 includes an RF signal generator and a power amplifier. In response to control signals provided by a system controller 330, the RF signal generator 322 is configured to produce an oscillating electrical signal having a frequency in the ISM (industrial, scientific, and medical) band, although the system could be modified to support operations in other frequency bands, as well. The RF signal generator (and, thereby, the RF signal source 322) may be controlled by controller 330 to produce oscillating signals of different power levels and/or different frequencies, in various embodiments. For example, RF signal source 322 may produce a signal that oscillates in a range from 1 MHz-1 GHz. In some cases, the RF signal source 322, for example, may output signals oscillating at specific frequencies, such as 13.56 MHz, 27 MHz, 40.68 MHz, and 915 MHz, for example, though in various embodiments of system 300, different frequencies may be utilized.

The cavity inside enclosure 306 and any load 314 (e.g., corn kernels) and container 304 positioned in the enclosure 306 present a cumulative load for the electromagnetic energy (or RF power) that is radiated by electrode 310 and electrode 312. This cumulative load presents an impedance to the system, referred to herein as a “cavity plus load impedance.” The cavity plus load impedance changes during a heating operation as the temperature of the load 314 increases, as the load 314 cooks, and as portions of the load 314 that have cooked (e.g., popped kernels) exit the cavity, as discussed above. Because of the changing impedance, the signal power transfer from RF the signal source 322 into the food load 314 may become inefficient over time. In most cases, it is desirable to maximize the magnitude of transferred signal power into the cavity formed by enclosure 306, and/or to minimize a reflected-to-forward signal power ratio along one or both of conductive paths 326 and 328.

Accordingly, system 300 includes power detection circuits 332 and 334 configured to monitor, measure, or otherwise detect the power of the reflected signals traveling along transmission path 326 and/or 328 between the RF signal source 322 and electrodes 310 and 312 (i.e., reflected RF signals traveling in a direction from electrodes 310 and 312 toward RF signal source 322). In some embodiments, power detection circuits 332 and 334 are also configured to detect the power of the forward signals traveling along one or more of the transmission paths 326 and 328 between the RF signal source 322 and electrodes 310 and 312 (i.e., forward RF signals traveling in a direction from RF signal source 322 toward electrodes 310 and 312).

Power detection circuits 332 and 334 supply signals to controller 330 conveying the magnitudes of the reflected signal power (and the forward signal power, in some embodiments) along one or both of paths 326, 328. In embodiments in which both the forward and reflected signal power magnitudes are conveyed, controller 330 may calculate a reflected-to-forward signal power ratio, or an S11 parameter, or a voltage standing wave ration (VSWR) value. As will be described in more detail below, when the reflected signal power magnitude exceeds a reflected signal power threshold, or when the reflected-to-forward signal power ratio exceeds an S11 parameter threshold, or when a VSWR value exceeds a VSWR threshold, this indicates that the system 300 is not adequately matched to the cavity plus load impedance, and that energy absorption by the load 314 may be sub-optimal. In such a situation, controller 330 orchestrates a process of altering the state of the variable impedance matching network 324 to drive the reflected signal power or the S11 parameter or the VSWR value toward or below a desired level (e.g., below the reflected signal power threshold, and/or the reflected-to-forward signal power ratio threshold, and/or the S11 parameter threshold, and/or the VSWR threshold), thus re-establishing an acceptable match and facilitating more optimal energy absorption by the load 314. In some cases, controller 330 may also modify a frequency of the RF signal being output by RF signal source 322 to optimize or improve the impedance match between RF signal source 322 and the cavity defined by enclosure 306 plus load 314 to provide more efficient energy transfer into the load 314.

During the cooking process, the impedance of the load 314 may continuously change over time. When the load 314 includes corn kernels, for example, the impedance of the load will change as the kernels heat up and water or moisture within the kernels turns into steam. Then, the impedance of the load will again change when one or more kernels in the load 314 pop into popped corn. The impedance of the load 314 will further change as kernels in the load 314 pop and exit container 304 and enclosure 306 via the methods described above.

Because the impedance of the load 314 will constantly change over time, controller 330 may provide control signals to the variable impedance matching network 324 and RF signal source 322, which cause modifications to the state of the variable impedance matching network 324 (e.g., by modifying the magnitude of impedance transformation performed by the network 324) and RF signal source 322 (e.g., by modifying a frequency and/or an output power of the signal output by the RF signal source 322) to improve the impedance match throughout the cooking process.

In an embodiment, the controller 330 establishes an initial state of the RF signal source 322 and variable impedance matching network 324 before the cooking process begins. The initial state may be determined, for example, based upon inputs provided by a user of system 300 via a suitable user interface (e.g., interface 120, FIG. 1 or interface 292, FIG. 2A). The input may identify the type of load (e.g., the type of grain) and volume of load to be cooked, and/or the characteristics of the container plus load. The controller 330 may then use those inputs to determine an initial configuration for variable impedance matching network 324 and RF signal source 322. For example, the controller 330 may use the inputs to access a lookup table that correlates particular attributes of a food load to a particular initial configuration of the variable impedance matching network 324 and RF signal source 322. Alternatively, data may be encoded into or associated with the particular container 304 utilized to contain the food load 314. The data (e.g., a bar code, quick response (QR) code, RFID, or other encoded data) may be read by controller 330 and similarly used to determine an initial configuration for both the variable impedance matching network 324 and RF signal source 322. Depending on the contents of the container 304 (e.g., the amount of the food (e.g., kernels) in the container 304, different additives, flavorings, oils, fats, or cooking bases), for example, different food loads may require a different initial configuration of the virtual impedance matching network 324 to achieve optimal impedance matching at the beginning of the cooking process. Accordingly, such data may be read by an electronic scanner 336 configured to read the data from the container 304 and communicate the data to controller 330. The data may be encoded, for example, as a bar code or QR code on an exterior surface of container 304, in which case scanner 336 may comprise a scanner device configured to read the code and transmit the data to controller 330. Similarly, the data may be encoded into an electronic tag (e.g., RFID tag) or otherwise encoded or associated with an ID of an electronic tag incorporated into the container 304. In that case, scanner 336 may comprise a suitable reader configured to wirelessly read the data from the tag and communicate the data to controller 330.

Once an initial setting for the variable impedance matching network 324 is determined, controller 330 may initiate the cooking process by causing RF signal source 322 to output an appropriate RF signal. During the cooking process, controller 330 modifies the state of the variable impedance matching network 324 (and, optionally, the output of RF signal source 322) based on signals received from the power detection circuits 332, 334 so that an adequate match may be maintained throughout the heating operation, despite changes in the impedance of the load 314.

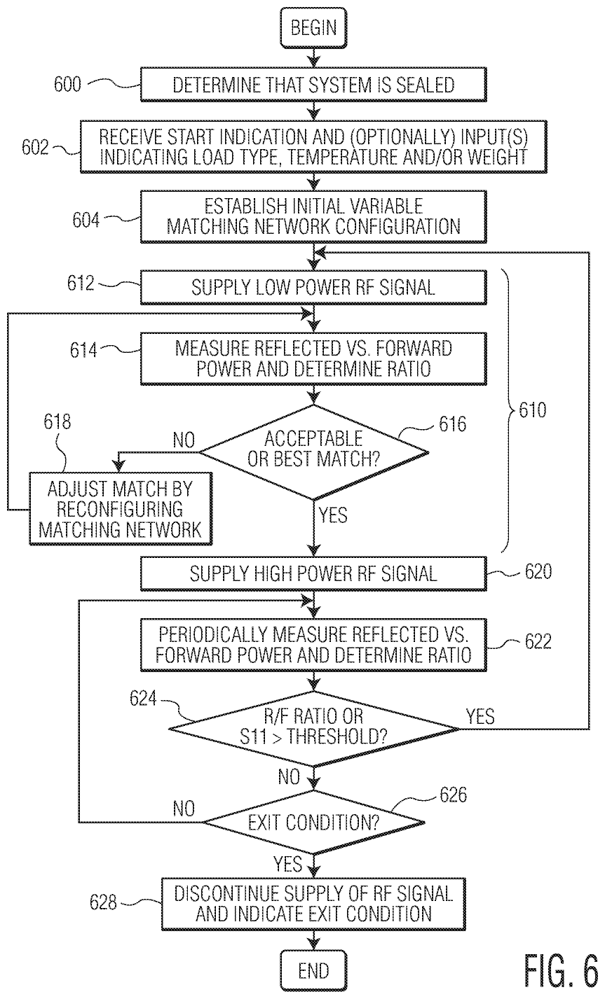

Now that embodiments of the electrical and physical aspects of heating systems have been described, various embodiments of methods for operating such systems will now be described. More specifically, FIG. 6 is a flowchart of a method of operating a heating system (e.g., system 100, 200, 300, FIGS. 1-3) with dynamic load matching, in accordance with an example embodiment.

The method may begin when a user places a load (e.g., load 314, contained within container 304, FIG. 3) into the system's enclosure (e.g., enclosure 306, FIG. 3), and seals the enclosure (e.g., by closing door 308).

In block 600, the system controller (e.g., controller 330, FIG. 3) receives an indication that the system has been sealed. For example, the system (e.g., the heating cavity of the system) may be sealed by fully engaging a container containing the food load (e.g., container 304, FIG. 3) into an enclosure (e.g., enclosure 306, FIG. 3), or by closing a door (e.g., door 308, FIG. 3) to fully enclose the cavity. This indication may be, for example, an electrical signal provided by a safety interlock disposed in or on the containment structure.

In block 602, the system controller (e.g., controller 330, FIG. 3) receives an indication that a heating operation should start. Such an indication may be received, for example, when the user has pressed a start button (e.g., of the user interface 120, 292, 1292, FIGS. 1, 2A, 2B). According to various embodiments, the system controller optionally may receive additional inputs indicating the load type, and/or the load weight or volume. For example, information regarding the load type may be received from the user through interaction with the user interface (e.g., by the user selecting from a list of recognized load types). Alternatively, the system may be configured to scan a barcode visible on the exterior of the container containing the load, or to receive an electronic signal from an RFID device on or embedded within the container. Information regarding the load weight or volume may be received from the user through interaction with the user interface, for example. As indicated above, receipt of inputs indicating the load type, and/or load weight or volume is optional, and the system alternatively may not receive some or all of these inputs.

In block 604, the system controller provides control signals to the variable matching network (e.g., 234, 270, 324, 123, 1270, FIGS. 2A, 2B, 3) to establish an initial configuration or state for the variable matching network. The initial configuration may be a configuration to which the variable matching network is set each time a heating process is initiated. In some cases, however, the initial configuration may be determined based upon input provided by a user of the system (e.g., via a user interface such as user interface 292 of FIG. 3) or based upon data retrieved from a container of the food load that has been inserted into the heating cavity of the system (e.g., via scanner 336 of FIG. 3).

Once the initial variable matching network configuration is established, the system controller may perform a process 610 of adjusting, when necessary, the configuration of the variable impedance matching network to find an acceptable or best match based on actual measurements that are indicative of the quality of the match. According to an embodiment, this process includes causing the RF signal source (e.g., RF signal source 322) to supply a relatively low power RF signal through the variable impedance matching network to an electrode (e.g., electrode 310 and/or 312), in block 612. For example, the relatively low power RF signal may be a signal having a power level in a range of about 10 W to about 20 W, although different power levels alternatively may be used. A relatively low power level signal during the match adjustment process 610 is desirable to reduce the risk of damaging the cavity or load (e.g., if the initial match causes high reflected power), and to reduce the risk of damaging the switching components of the variable inductance networks (e.g., due to arcing across the switch contacts).

In block 614, power detection circuitry (e.g., power detection circuitry 230, 332, 334, 1230, FIGS. 2A, 2B, 3) then measures the forward and/or reflected signal power along the transmission path from the RF signal source to the electrode (e.g., path 228, 326, 328, 1228, FIGS. 2A, 2B, 3), and provides those measurements to the controller. The controller may then determine a ratio between the reflected and forward signal powers, and may determine the S11 parameter for the system based on the ratio. The system controller may store the calculated ratios and/or S11 parameters for future evaluation or comparison, in an embodiment.

In block 616, the system controller may determine, based on the reflected-to-forward signal power ratio and/or the S11 parameter and/or the reflected signal power magnitude, whether or not the match provided by the variable impedance matching network is acceptable (e.g., the ratio is 10 percent or less, or compares favorably with some other criteria). Alternatively, the system controller may be configured to determine whether the match is the “best” match. A “best” match may be determined, for example, by iteratively measuring the forward and/or reflected RF power for a number of possible impedance matching network configurations (or at least for a defined subset of impedance matching network configurations), and determining which configuration results in the lowest reflected-to-forward power ratio or reflected power magnitude. In addition to iteratively measuring the reflected RF power (or both the forward and reflected RF power) for a number of possible impedance matching network configurations, the controller may also adjust the frequency of the RF signal source to identify a particular impedance matching network configuration and RF signal frequency that provides an optimal or acceptable match.

When the system controller determines that the match is not acceptable or is not the best match, the system controller may adjust the match, in block 618, by reconfiguring the variable inductance matching network or modifying the output of the RF signal source. For example, this may be achieved by sending control signals to the variable impedance matching network, which cause the network to increase and/or decrease the variable passive components (e.g., inductances and/or capacitances) within the network or by modifying an output (e.g., the frequency) of the signal output by the RF signal source. After reconfiguring the variable impedance matching network, blocks 614, 616, and 618 may be iteratively performed until an acceptable or best match is determined in block 616.

Once an acceptable or best match is determined, the heating operation may commence. Commencement of the heating operation includes increasing the power of the RF signal supplied by the RF signal source (e.g., RF signal source 220, 322, 1220, FIGS. 2A, 2B, 3) to a relatively high power RF signal, in block 620. For example, the relatively high power RF signal may be a signal having a power level in a range of about 50 W to about 300 W, although different power levels alternatively may be used.

In block 622, power detection circuitry (e.g., power detection circuitry 230, 332, 334, 1230, FIGS. 2A, 2B, 3) then periodically measures the reflected signal power (or both the forward and reflected signal power) along the transmission path (e.g., path 228, 326, 328, 1228, FIGS. 2A, 2B, 3) between the RF signal source and the electrode(s), and provides those measurements to the system controller. The system controller again may determine a ratio between the reflected and/or forward signal powers, and may determine the S11 parameter for the system based on the ratio. The system controller may store the calculated ratios and/or S11 parameters and/or reflected power magnitudes for future evaluation or comparison, in an embodiment. According to an embodiment, the periodic measurements of the forward and/or reflected power may be taken at a fairly high frequency (e.g., on the order of milliseconds) or at a fairly low frequency (e.g., on the order of seconds). For example, a fairly low frequency for taking the periodic measurements may be a rate of one measurement every 10 seconds to 20 seconds.

In block 624, the system controller may determine, based on one or more calculated reflected-to-forward signal power ratios and/or one or more calculated S11 parameters and/or one or more reflected power magnitude measurements, whether or not the match provided by the variable impedance matching network is acceptable. For example, the system controller may use a single calculated reflected-to-forward signal power ratio or S11 parameter or reflected power measurement in making this determination, or may take an average (or other calculation) of a number of previously-calculated reflected-to-forward power ratios or S11 parameters or reflected power measurements in making this determination. To determine whether or not the match is acceptable, the system controller may compare the calculated ratio and/or S11 parameter and/or reflected power measurement to a threshold, for example. For example, in one embodiment, the system controller may compare the calculated reflected-to-forward signal power ratio to a threshold of 10 percent (or some other value). A ratio below 10 percent may indicate that the match remains acceptable, and a ratio above 10 percent may indicate that the match is no longer acceptable. When the calculated ratio or S11 parameter or reflected power measurement is greater than the threshold (i.e., the comparison is unfavorable), indicating an unacceptable match, then the system controller may initiate re-configuration of the variable impedance matching network by again performing process 610. As discussed previously, the match provided by the variable impedance matching network may degrade over the course of a heating operation due to impedance changes of the load as the load warms up and exits the load's container and, ultimately, the enclosure containing the heating cavity. For example, the controller may iteratively test adjacent variable impedance matching network configurations to attempt to determine an acceptable configuration.

In actuality, there are a variety of different searching methods that the controller may employ to re-configure the system to have an acceptable impedance match, including testing all possible variable impedance matching network configurations and modifying the output (e.g., frequency) of the RF signal source output. Any reasonable method of searching for an acceptable configuration is considered to fall within the scope of the inventive subject matter. In any event, once an acceptable match is determined in block 616, the heating operation is resumed in block 620, and the process continues to iterate.

Referring back to block 624, when the system controller determines, based on one or more calculated reflected-to-forward signal power ratios and/or one or more calculated S11 parameters and/or one or more reflected power measurements, that the match provided by the variable impedance matching network is still acceptable (e.g., the calculated ratio or S11 parameter is less than the threshold, or the comparison is favorable), the system may evaluate whether or not an exit condition has occurred, in block 626. In actuality, determination of whether an exit condition has occurred may be an interrupt driven process that may occur at any point during the heating process. However, for the purposes of including it in the flowchart of FIG. 6, the process is shown to occur after block 624.

In any event, several exit conditions may warrant cessation of the heating operation. For example, the system may determine that an exit condition has occurred when a safety interlock is breached (e.g., the drawer/door has been opened). Alternatively, the system may determine that an exit condition has occurred upon expiration of a timer that was set by the user (e.g., through user interface 292, 1292, FIGS. 2A, 2B) or upon expiration of a timer that was established by the controller based on the system controller's estimate of how long the heating operation should be performed, which may be determined based upon data retrieved from the container of the food load, or based on an ID value retrieved therefrom. Alternatively, the system may determine that an exit condition has occurred upon determining that substantially all of the food load has exited the container.

If an exit condition has not occurred, then the heating operation may continue by iteratively performing blocks 622 and 624 (and the re-matching process 610, as necessary). When an exit condition has occurred, then in block 628, the controller causes the supply of the RF signal by the RF signal source to be discontinued. For example, the system controller may disable the RF signal source to discontinue provision of the RF signal. In addition, the system controller may send signals to the user interface (e.g., user interface 120, 292, 1292, FIGS. 2A, 2B, 3) that cause the user interface to produce a user-perceptible indicia of the exit condition. The method may then end.

In an embodiment, a system includes a cavity configured to receive a container. The container is configured to contain a plurality of grains. The system includes a radio frequency (RF) signal source configured to supply an RF signal, an impedance matching network electrically coupled to an output of the RF signal source, a transmission path coupled to the impedance matching network, and a first electrode in the cavity. The first electrode is coupled to the transmission path and configured to radiate electromagnetic energy into the cavity as a result of receiving the RF signal. The system includes power detection circuitry configured to measure a magnitude of a reflected signal along the transmission path and a controller configured to modify an impedance transformation performed by the impedance matching network based on the magnitude of the reflected signal.

In another embodiment, a system includes a cavity, a radio frequency (RF) signal source configured to supply an RF signal, and a first electrode in the cavity. The first electrode is coupled to a first output of the RF signal source. The system includes a second electrode in the cavity. The second electrode includes at least one hole extending through the electrode from a first surface of the second electrode to a second surface of the second electrode and the second electrode is connected to a ground reference voltage or a second output of the RF signal source. The system includes a controller configured to cause the RF signal source to supply the RF signal to either or both the first electrode and the second electrode.

In another embodiment, the system includes a cavity configured to receive a container. The container defines a cooked food exit region. The system includes a radio frequency (RF) signal source configured to supply an RF signal, and a first electrode in the cavity. The first electrode is coupled to a first output of the RF signal source or a ground reference voltage and the first electrode includes a first hole extending through the first electrode from a first surface of the first electrode to a second surface of the first electrode and the first hole is positioned underneath the cooked food exit region of the container when the container is disposed within the cavity. The system includes a controller configured to cause the RF signal source to supply the RF signal to the first electrode.

The connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus are not intended to be limiting, and the terms “first”, “second” and other such numerical terms referring to structures do not imply a sequence or order unless clearly indicated by the context.

As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node).

The foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with) another element, and not necessarily mechanically. Thus, although the schematic shown in the figures depict one exemplary arrangement of elements, additional intervening elements, devices, features, or components may be present in an embodiment of the depicted subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A system, comprising:
a cavity configured to receive a container, wherein the container is configured to contain a plurality of grains;
a radio frequency (RF) signal source configured to supply an RF signal;
an impedance matching network electrically coupled to an output of the RF signal source;
a transmission path coupled to the impedance matching network;
a first electrode in the cavity, wherein the first electrode is coupled to the transmission path and configured to radiate electromagnetic energy into the cavity as a result of receiving the RF signal;
power detection circuitry configured to measure a magnitude of a reflected signal along the transmission path; and
a controller configured to modify an impedance transformation performed by the impedance matching network based on the magnitude of the reflected signal.

2. The system of claim 1, wherein the first electrode is positioned at one side of the container when the container is positioned within the cavity, and the first electrode includes a plurality of holes, each hole in the plurality of holes extending through the first electrode from a first surface of the first electrode to a second surface of the first electrode.

3. The system of claim 2, wherein each hole in the plurality of holes has a diameter equal to or greater than 1 centimeter.

4. The system of claim 2, wherein the container includes a number of cooked food exit regions and each hole in the plurality of holes is located underneath a cooked food exit region of the container when the container is positioned in the cavity.

5. The system of claim 1, wherein a frequency of the RF signal is between 1 megahertz and 300 megahertz.

6. The system of claim 1, further comprising a second electrode disposed in the cavity and wherein a distance between the electrode and the second electrode is equal to or less than 6 centimeters.

7. The system of claim 6, wherein the RF signal source is configured to supply a second RF signal and further comprising:
a second impedance matching network electrically coupled to a second output of the RF signal source; and
a second transmission path coupled to the second impedance matching network, and wherein the second electrode is coupled to the second transmission path and configured to radiate second electromagnetic energy into the cavity of as a result of receiving the second RF signal.

8. The system of claim 6, wherein the second electrode is connected to a ground reference voltage.

9. The system of claim 6, wherein the first electrode is a ring electrode and includes a hole extending through the first electrode from a first surface of the first electrode to a second surface of the first electrode, wherein the hole has a diameter greater than or equal to 6 centimeters.

10. A system, comprising:
a cavity;
a radio frequency (RF) signal source configured to supply an RF signal;
a first electrode in the cavity, wherein the first electrode is coupled to a first output of the RF signal source;
a second electrode in the cavity, wherein the second electrode includes at least one hole extending through the electrode from a first surface of the second electrode to a second surface of the second electrode and the second electrode is connected to a
ground reference voltage or a second output of the RF signal source; and
a controller configured to cause the RF signal source to supply the RF signal to either or both the first electrode and the second electrode.

11. The system of claim 10, wherein the second electrode defines a plurality of holes, each hole in the plurality of holes extending through the electrode from the first surface of the electrode to the second surface of the electrode.

12. The system of claim 11, wherein each hole in the plurality of holes has a diameter equal to or greater than 1 centimeter.

13. The system of claim 12, wherein a frequency of the RF signal is between 1 megahertz and 300 megahertz.

14. The system of claim 10, wherein the second electrode is a ring electrode and includes a hole extending through the second electrode from the first surface of the electrode to the second surface of the electrode.

15. The system of claim 10, wherein the cavity includes a first sidewall and a second sidewall, a first retention structure on the first sidewall and a second retention structure on the second sidewall, the first retention structure and the second retention structure being configured to retain a container between the first electrode and the second electrode.

16. The system of claim 15, wherein the container defines one or more cooked food exit regions, and the at least one hole in the second electrode are positioned underneath the cooked food exit regions when the container is retained between the first electrode and the second electrode.

17. A system, comprising:
a cavity configured to receive a container, wherein the container defines a cooked food exit region;
a radio frequency (RF) signal source configured to supply an RF signal;
a first electrode in the cavity, wherein the first electrode is coupled to a first output of the RF signal source or a ground reference voltage and the first electrode includes a first hole extending through the first electrode from a first surface of the first electrode to a second surface of the first electrode and the first hole is positioned underneath the cooked food exit region of the container when the container is disposed within the cavity; and
a controller configured to cause the RF signal source to supply the RF signal to the first electrode.

18. The system of claim 17, wherein the first hole has a diameter greater than or equal to 6 centimeters.

19. The system of claim 17, wherein the first electrode includes a second hole extending through the first electrode from a first surface of the first electrode to a second surface of the first electrode and the first hole and the second hole each have diameters equal to or greater than 1 centimeter.

20. The system of claim 17, further comprising a second electrode disposed in the cavity, wherein the second electrode is coupled to the RF signal source and a distance between the first electrode and the second electrode is equal to or less than 6 centimeters.
